(19) United States
(12) Patent Application Publication
(10) Pub. No.: US 2016/0342133 A1
(43) Pub. Date: Nov. 24, 2016

(54) IMAGE FORMING APPARATUS AND CARTRIDGE USED THEREIN

(71) Applicant: CANON KABUSHIKI KAISHA, Tokyo (JP)

(72) Inventors: Daisuke Hiramatsu, Tokyo (JP); Tomonori Mori, Numazu-shi (JP); Ken Kikuchi, Mishima-shi (JP)

(21) Appl. No.: 15/156,600

(22) Filed: May 17, 2016

(30) Foreign Application Priority Data
May 21, 2015 (JP) 2015-103558

(51) Int. Cl. G03G 15/08

(52) U.S. Cl. CPC G03G 21/1676; G03G 21/1647

(57) ABSTRACT

An image forming apparatus includes a main assembly and a cartridge. The main assembly includes a mounting portion for mounting the cartridge and a door for causing the mounting portion to be in an open state and a closed state. The main assembly or the cartridge includes an expansion and contraction member for displacing at least a part of the cartridge. Opening and closing of the door is interrelated with expansion and contraction of the expansion and contraction member. In the closed state, the cartridge mounted in the mounting portion is in a first position, inside the main assembly, where an image is formable. In the open state, the cartridge mounted in the mounting portion is in a second position where at least a part thereof projects to an outside of the main assembly.

### FIELD OF THE INVENTION AND RELATED ART

The present invention relates to an image forming apparatus and a cartridge used therein and is suitable for the image forming apparatus, such as a copying machine or a printer, employing an electrophotographic recording process or an electrostatic recording process.

Conventionally, in an electrophotographic image forming apparatus using an electrophotographic image forming process, a cartridge type in which process means and the like are provided as a unit so as to be exchangeable from an apparatus main assembly portion of the image forming apparatus is employed. As a cartridge employing the cartridge type, there is a developing cartridge including a developing roller and the like. Further, as the cartridge employing the cartridge type, there is a process cartridge in which an electrophotographic photosensitive drum and process means actable on the photosensitive drum are integrally assembled into a cartridge. The process cartridge may also be prepared by providing a photosensitive member integrally with the developing cartridge including the developing roller as the process means.

Further, there is a toner cartridge type in which a toner cartridge capable of supplying toner (developer) is provided detachably mountable to the developing cartridge including the developing roller and the like or an image forming apparatus main assembly. The toner cartridge can be exchanged separately from another part (component), such as the photosensitive drum or the developing roller, constituting the developing cartridge or the image forming apparatus main assembly. For that reason, the toner cartridge is effective in the case where consumption of the toner accommodated in a toner accommodating unit and a life cycle of another part, such as the photosensitive drum or the developing roller, constituting the developing cartridge or the image forming apparatus main assembly and different from each other.

In such a toner cartridge type, such a constitution that the toner cartridge is partly exposed from a toner cartridge mounting portion of the image forming apparatus main assembly and a user grips an exposed portion when the toner cartridge is exchanged and thus exchange of the toner cartridge is facilitated has been known (Japanese Laid-Open Patent Application (JP-A) 2002-99130).

Further, such a constitution that the toner cartridge includes a grip portion which is partly exposed from a toner cartridge mounting portion of the image forming apparatus main assembly and a user grips the grip portion when the toner cartridge is exchanged and thus exchange of the toner cartridge is facilitated has been known (JP-A 2010-134023).

However, in JP-A 2002-99130, when a new cartridge for exchange is mounted, due to absence of a cartridge mounting portion at a shallow position inside an apparatus main assembly, there was a need that the user gripped the toner cartridge and then reached into the image forming apparatus main assembly with hard.

Further, in JP-A 2010-134023, depending on a direction of the grip portion when a door was closed, the grip portion was not rotated when the door was opened and therefore there was a need that the user reached into the image forming apparatus main assembly with hand and rotated the grip portion and the exchange the cartridge while gripping the grip portion. Further, a self-weight of the grip portion itself was used, and therefore the cartridge exchanged was realizable when a pulling-out direction of the cartridge was a horizontal direction, but was unrealizable when the pulling-out direction of the cartridge was a vertical direction.

### SUMMARY OF THE INVENTION

A principal object of the present invention is to provide an image forming apparatus capable of exchanging a cartridge with no need that a user reaches into an image forming apparatus main assembly with hand.

Another object of the present invention is to provide a cartridge used in the image forming apparatus.

According to an aspect of the present invention, there is provided an image forming apparatus comprising: a main assembly; and a cartridge capable of supplying developer and detachably mountable to the main assembly, wherein the main assembly includes a mounting portion for mounting the cartridge and a door for causing the mounting portion to be in an open state and a closed state, wherein the main assembly or the cartridge includes an expansion and contraction member for displacing at least a part of the cartridge, wherein opening and closing of the door is interrelated with expansion and contraction of the expansion and contraction member, wherein in the closed state, the cartridge mounted in the mounting portion is in a first position, inside the main assembly, where an image is formable, and wherein in the open state, the cartridge mounted in the mounting portion is in a second position where at least a part thereof projects to an outside of the main assembly.

According to another aspect of the present invention, there is provided an cartridge capable of supplying developer and detachably mountable to a main assembly of an image forming apparatus including a mounting portion and a door for causing the mounting portion to be in an open state and a closed state, the cartridge comprising: a grip portion; and an expansion and contraction member for displacing the grip portion while maintaining the cartridge at a position where the cartridge is mounted in the mounting portion, wherein the grip portion is in a first position where an image is formable inside the main assembly in the closed state and is in a second position where the grip portion projects to an outside of the main assembly in the open state.

Further features of the present invention will become apparent from the following description of exemplary embodiments with reference to the attached drawings.

### BRIEF DESCRIPTION OF THE DRAWINGS

FIG. 1 is a perspective view of an outer appearance of an image forming apparatus according to First Embodiment.

In FIG. 2, (a) is a perspective view of an outer appearance of the image forming apparatus in a state in which a door for toner cartridge exchange of the image forming apparatus, and (b) is an perspective view of an outer appearance of the image forming apparatus before the toner cartridge in First Embodiment is mounted into a toner supplying unit or after the toner cartridge is demounted from the toner supplying unit.

In FIG. 3, (a) is a sectional view, from a right side direction, showing a state in which the toner cartridge is mounted in the toner supplying unit, and (b) is a sectional view, from the right side direction, showing a state in which the toner cartridge is pulled out from the toner supplying unit in a vertical direction.

FIG. 4A is a sectional view, from a left side direction, showing the image forming apparatus, and FIG. 4B is a sectional view, from the right side direction, showing the image forming apparatus.

FIG. 5A is a sectional view, from the right side direction, showing the toner supplying unit in a state in which the door is opened, and FIG. 5B is a sectional view, from the right side direction, showing the toner supplying unit in a state in which the door is closed.

In FIG. 6, (a) is a sectional view, from the right side direction, showing a toner cartridge mounting portion in an unmounted state of the toner cartridge, and (b) is an enlarged sectional view, from the right side direction, showing a mounting location of the toner cartridge in the unmounted state of the toner cartridge.

FIG. 7A is a sectional view, from a left side direction, showing an image forming apparatus according to Second Embodiment, and FIG. 7B is a sectional view, from a right side direction, showing the image forming apparatus.

FIG. 8 is a perspective view of an outer appearance of the image forming apparatus in a state in which a door for toner cartridge exchange is Second Embodiment is opened.

FIG. 9A is a sectional view, from the right side direction, showing the toner supplying unit in a state in which the door is opened, and FIG. 9B is a sectional view, from the right side direction, showing the toner supplying unit in a state in which the door is closed.

In FIG. 10, (a) is a sectional view, from the right side direction, showing a toner cartridge in a state in which the toner cartridge is mounted in a toner supplying unit and then the door is opened, and (b) is a sectional view, from the right side direction, showing the toner cartridge in a state in which the toner cartridge mounted in the toner supplying unit and then the door is closed.

In FIG. 11, (a) is perspective view of an outer appearance of the image forming apparatus before the toner cartridge is mounted into the toner supplying unit or after the toner cartridge is demounted from the toner supplying unit, and (b) is a sectional view, from the right side direction, showing the toner cartridge in a state in which the toner cartridge is mounted from the toner supplying unit.

In FIG. 12, (a) is a sectional view, from the right side direction, showing a toner cartridge mounting portion in an unmounted state of the toner cartridge, and (b) is an enlarged sectional view, from the right side direction, showing a mounting location of the toner cartridge in the unmounted state of the toner cartridge.

FIG. 13A is a perspective view of an outer appearance of an image forming apparatus according to Third Embodiment, and FIG. 13B is a sectional view, from a left side direction, showing the image forming apparatus.

FIG. 14 is a perspective view of an outer appearance of the image forming apparatus in a state in which a door is opened.

FIG. 15A is a sectional view, from the left side direction, showing a developing cartridge mounting portion in a state in which the door is opened, FIG. 15B is a sectional view, from the left side direction, showing the developing cartridge mounting portion in a state in which the door is closed, and FIG. 15C is a sectional view, from the left side direction, showing the developing cartridge mounting portion in a state in which the door is opened with a certain angle.

FIG. 16 is a perspective view of an outer appearance of the image forming apparatus before the developing cartridge is mounted into the developing cartridge mounting portion or after the developing cartridge is demounted from the developing cartridge mounting portion.

In FIG. 17, (a) is a left side view of the developing cartridge in a state in which a grip portion in Third Embodiment is in a second position, (b) is a left side view of the developing cartridge in a state in which the grip portion is in a first position.

In FIG. 18, (a) is a sectional view, from the left side direction, showing the developing cartridge grip portion in the second position, (b) is a sectional view, from the left side direction, showing the developing cartridge grip portion in the first position, and (c) is a sectional view, from a front (surface) direction, showing the developing cartridge grip portion.

In FIG. 19, (a) is a perspective view, from a left direction, showing the developing cartridge mounting portion in a state in which the door of the image forming apparatus is opened and then the developing cartridge is demounted, and (b) is a perspective view, from a left direction, showing the developing cartridge mounting portion is demounted.

FIG. 20 is a sectional view, from the left side direction, showing the developing cartridge mounting portion.

### DESCRIPTION OF THE EMBODIMENTS

Embodiments according to the present invention will be described with reference to the drawings. However, dimensions, materials, shapes and relative arrangement of constituent elements described in the following embodiments are not intended such that the scope of the present invention is limited only thereto unless otherwise specified.

### First Embodiment

### Image Forming Apparatus

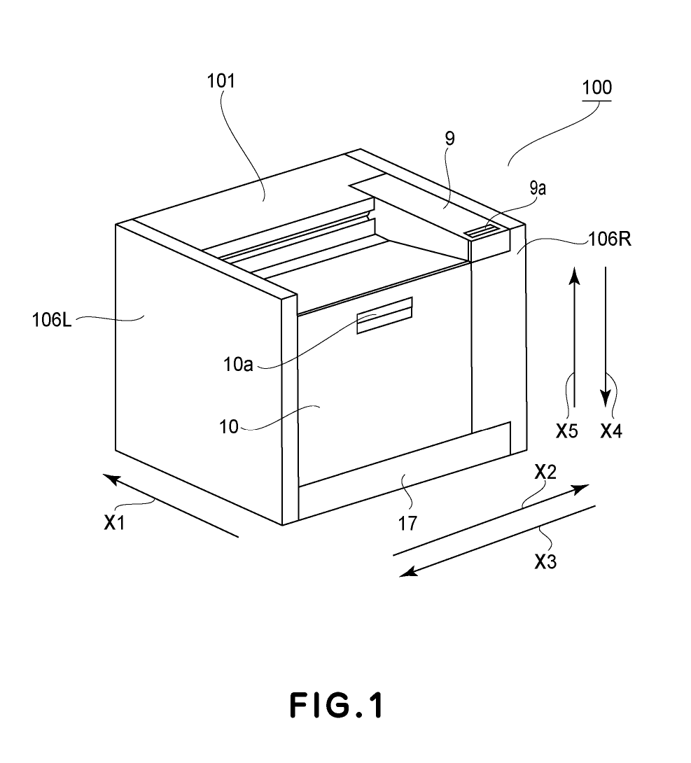

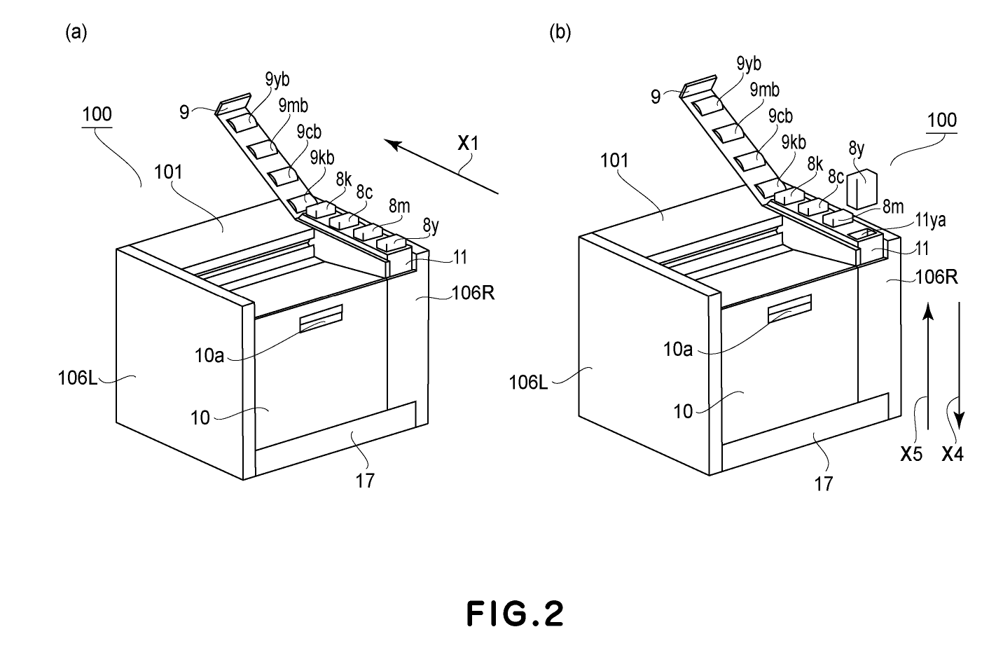

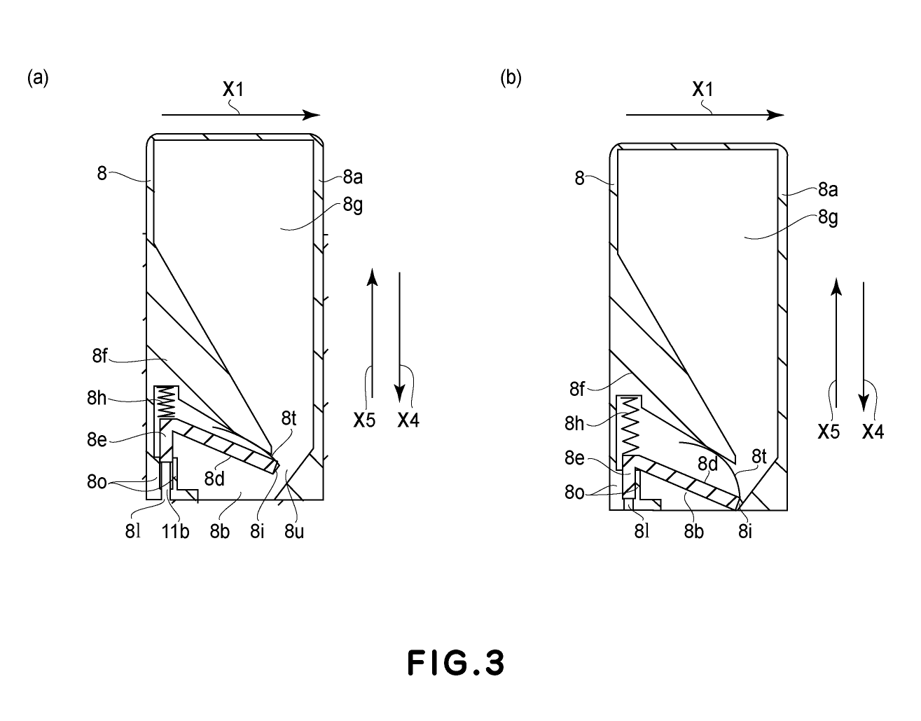

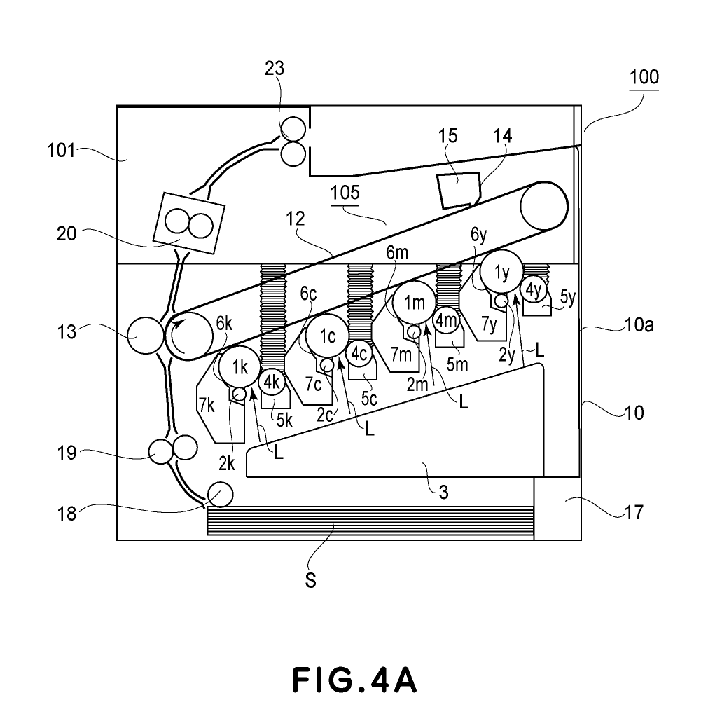

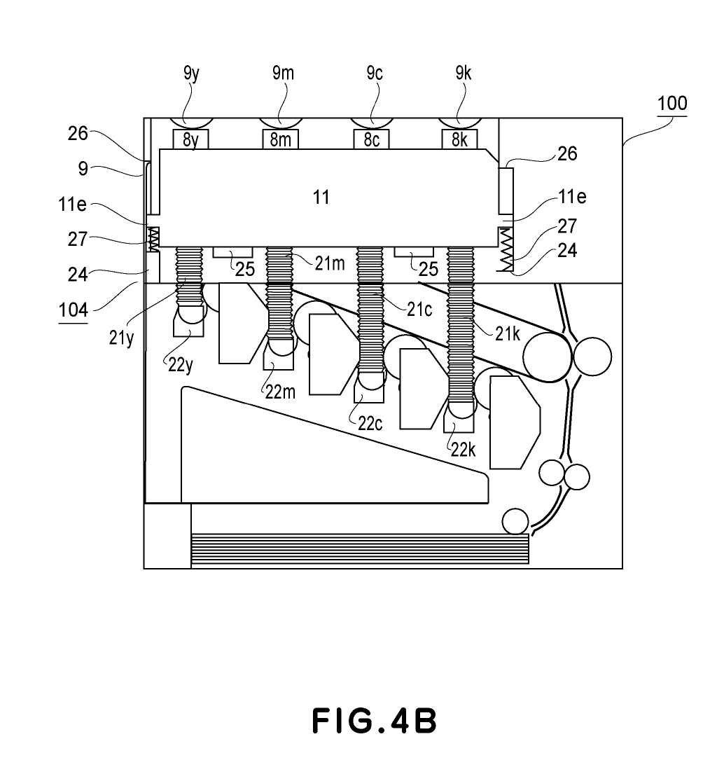

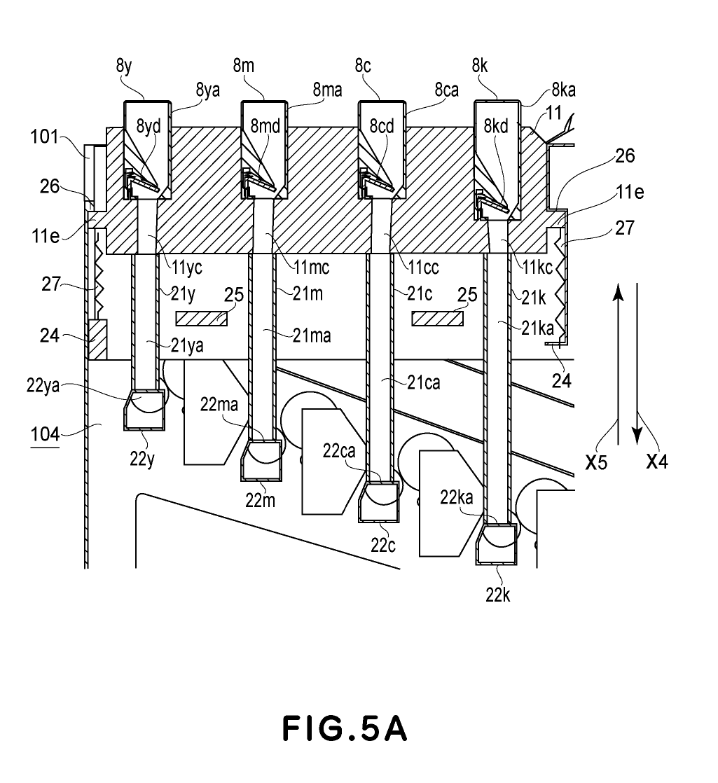

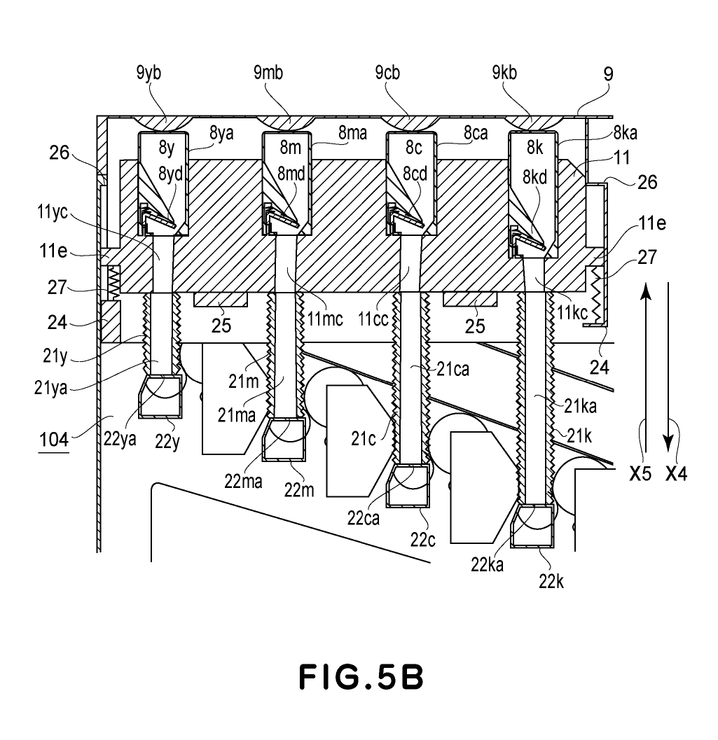

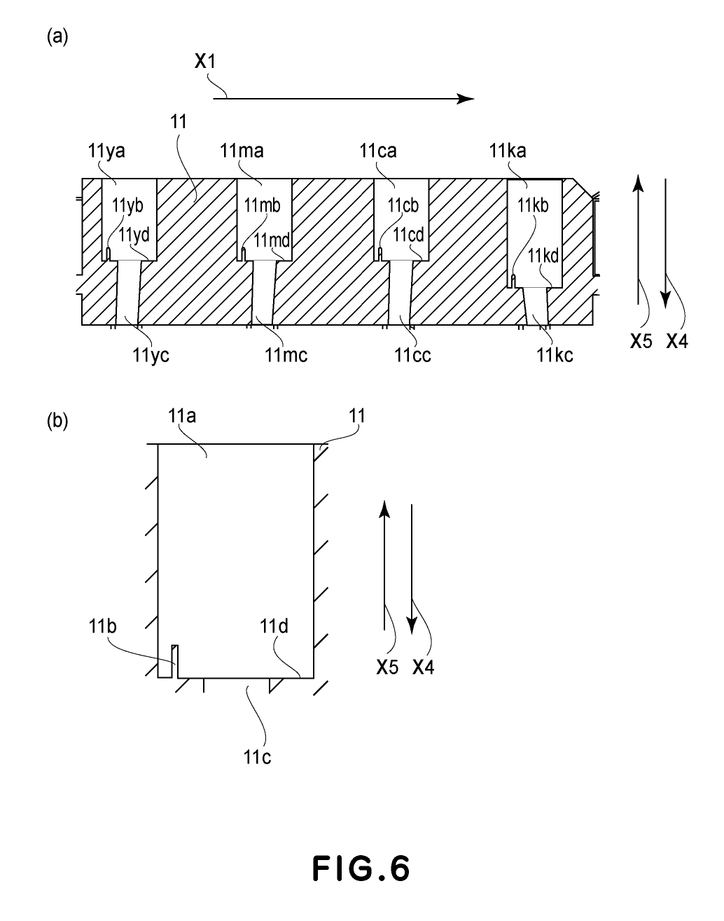

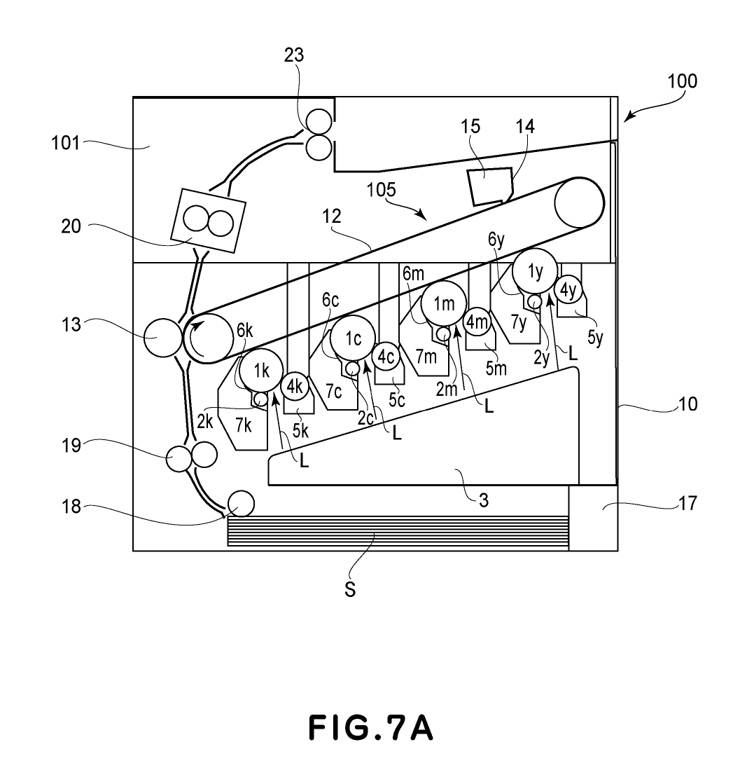

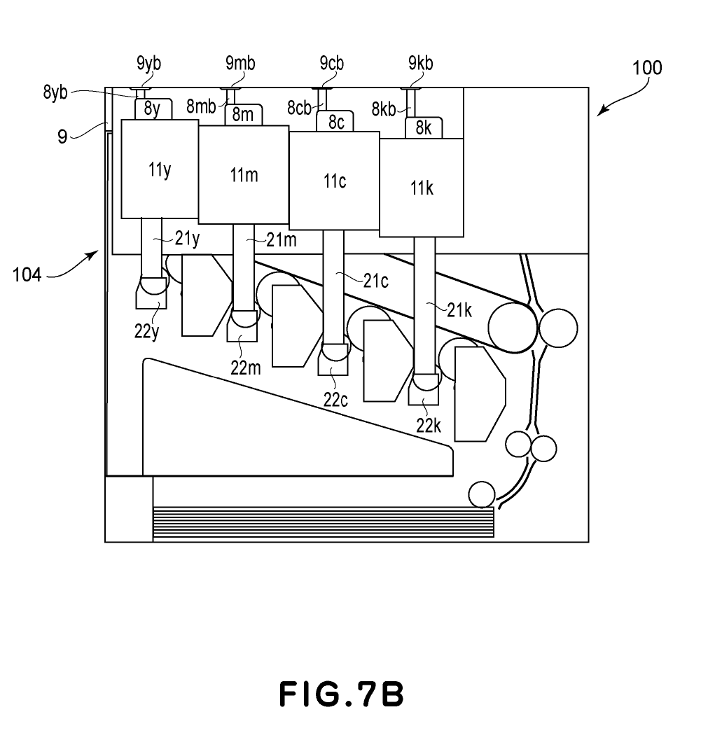

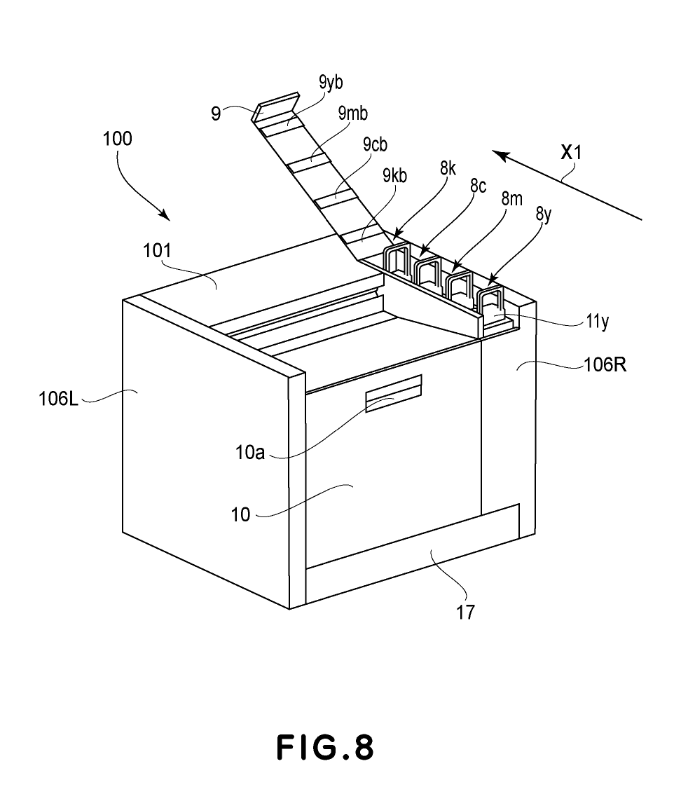

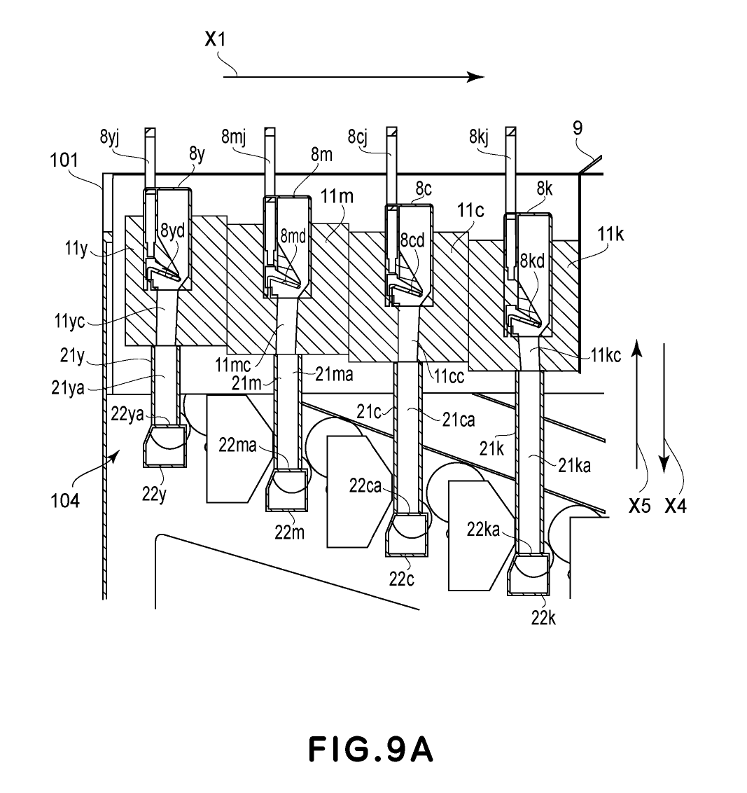

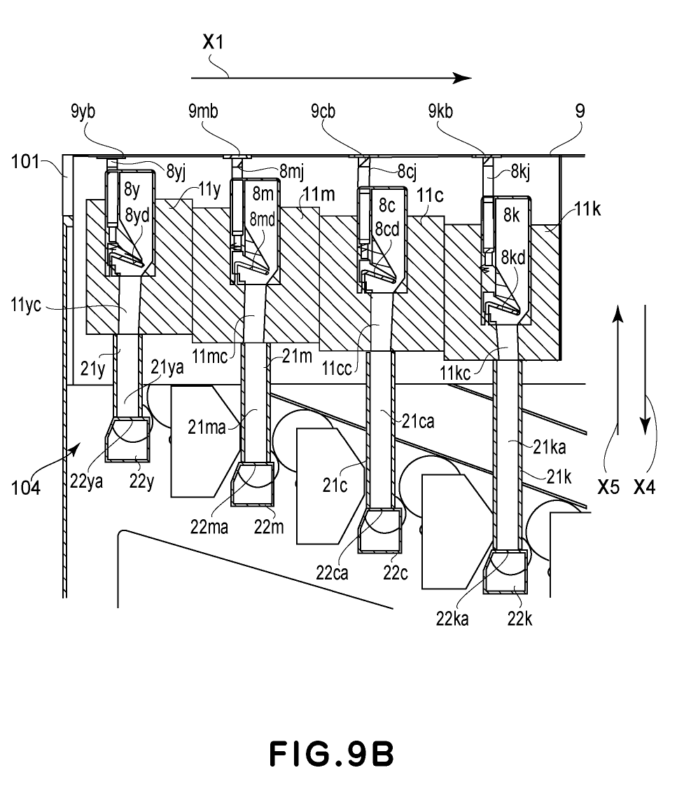

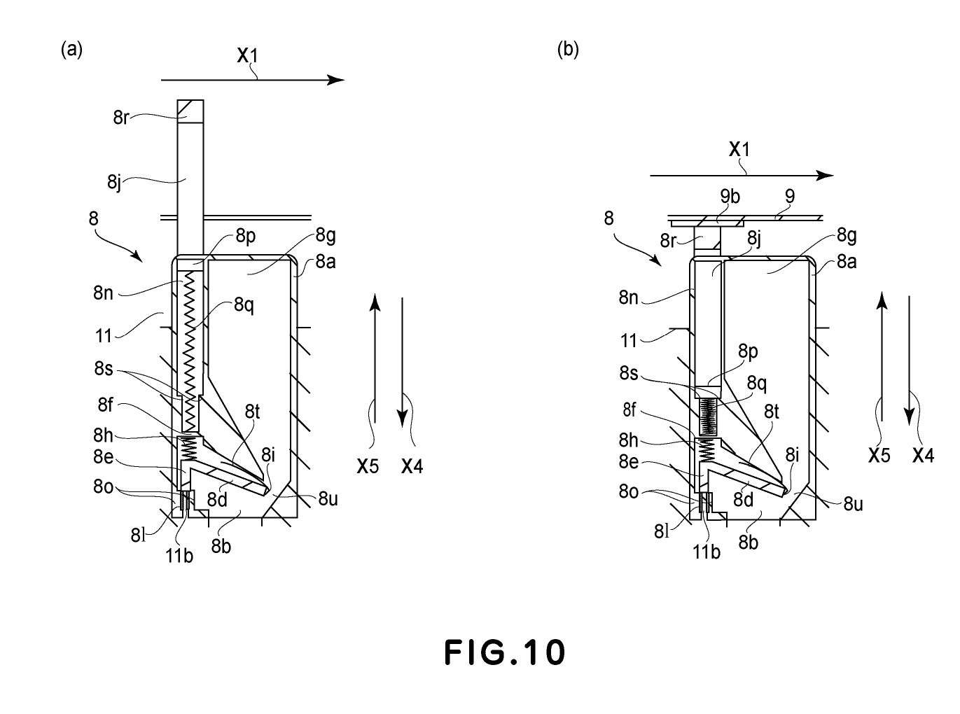

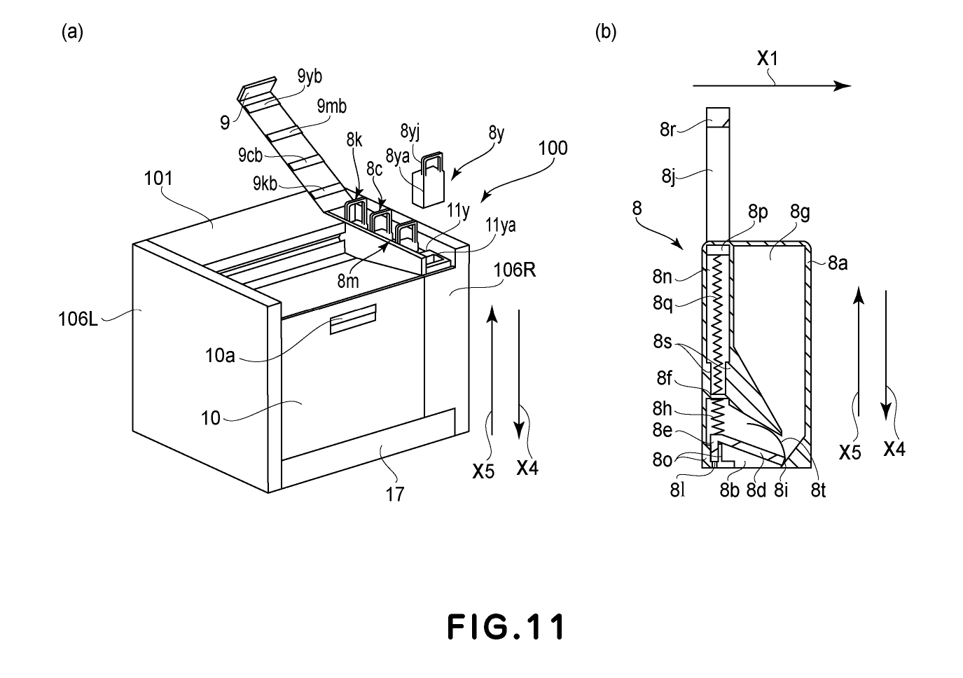

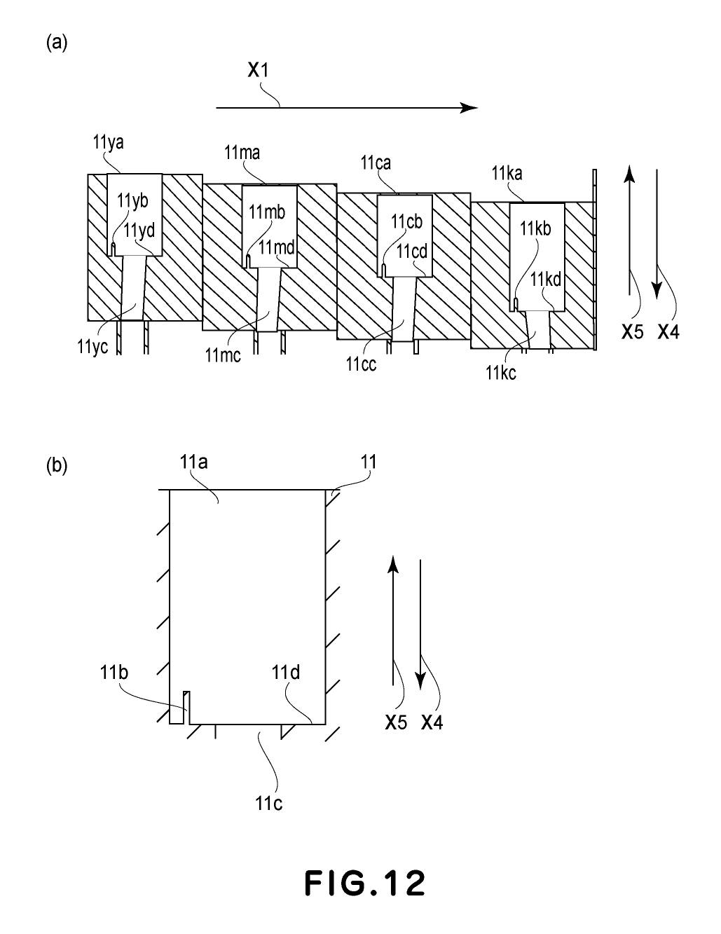

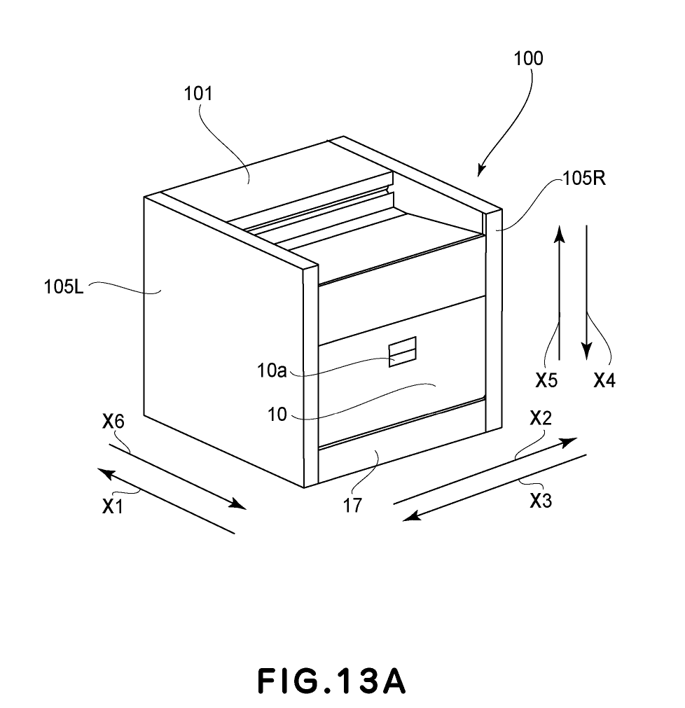

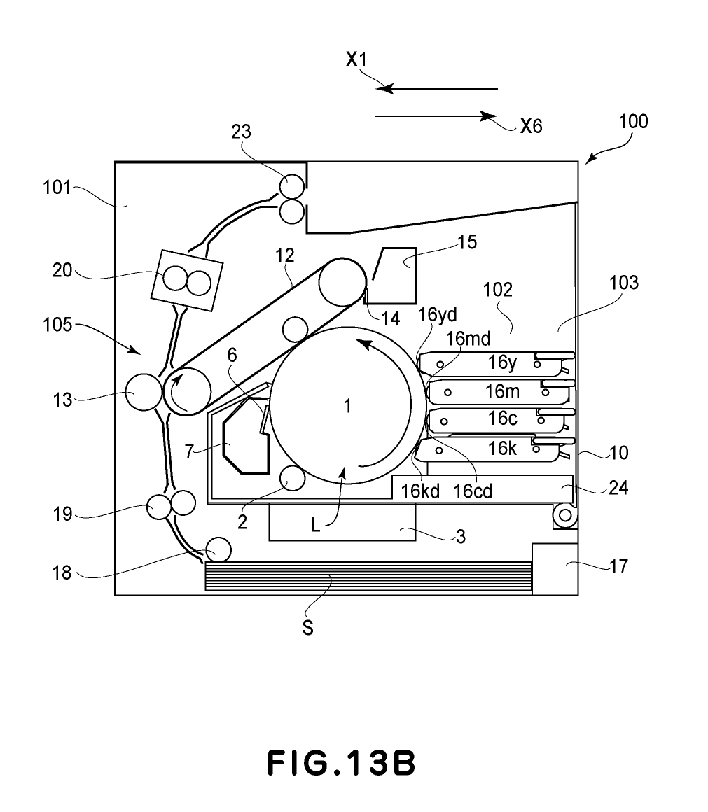

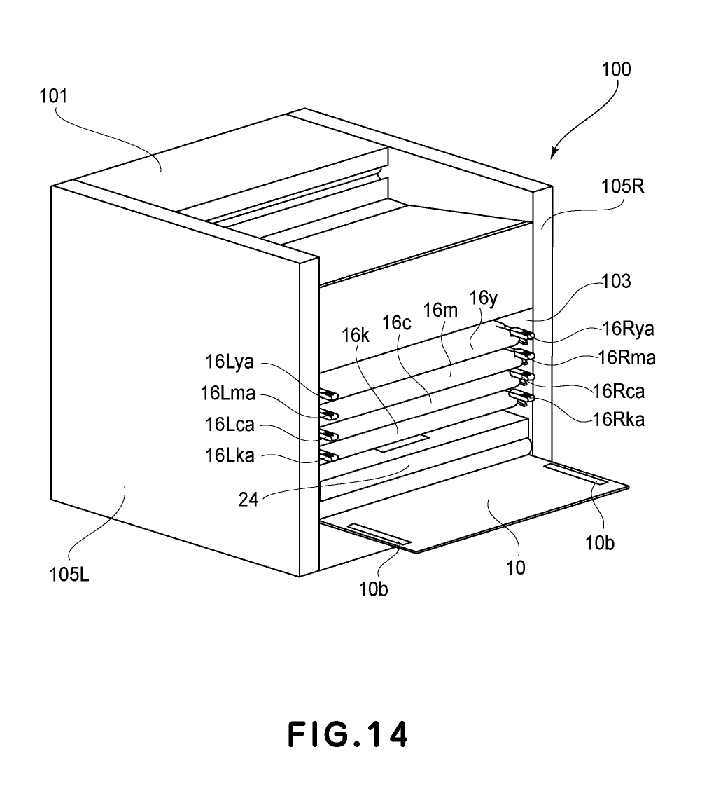

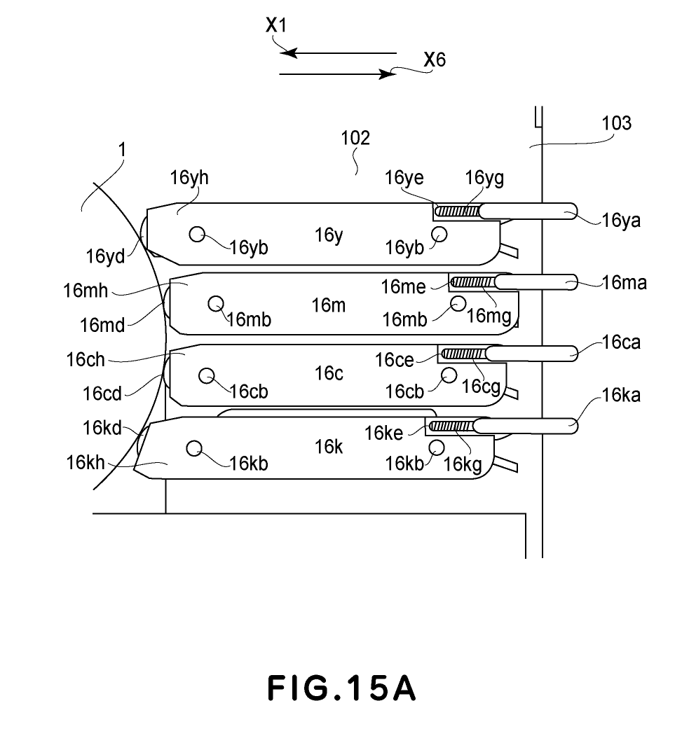

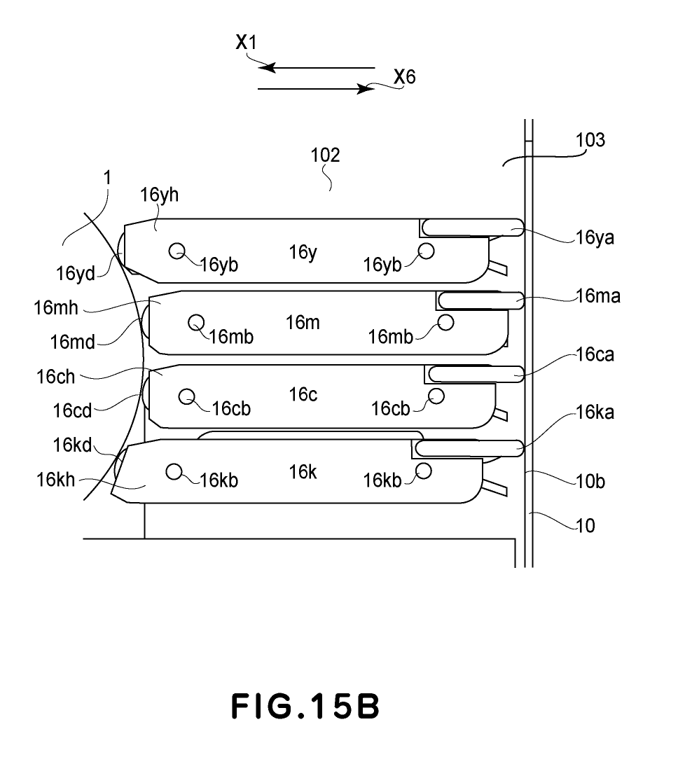

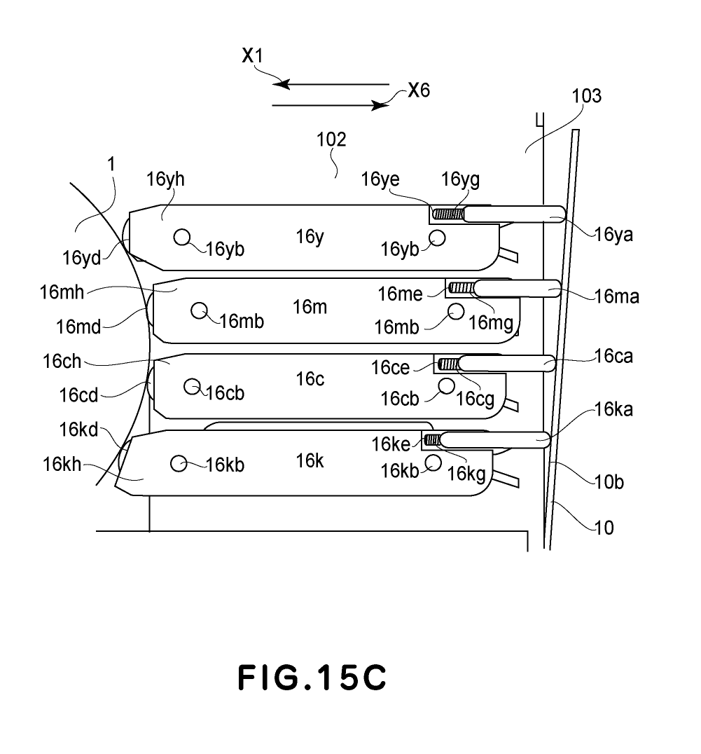

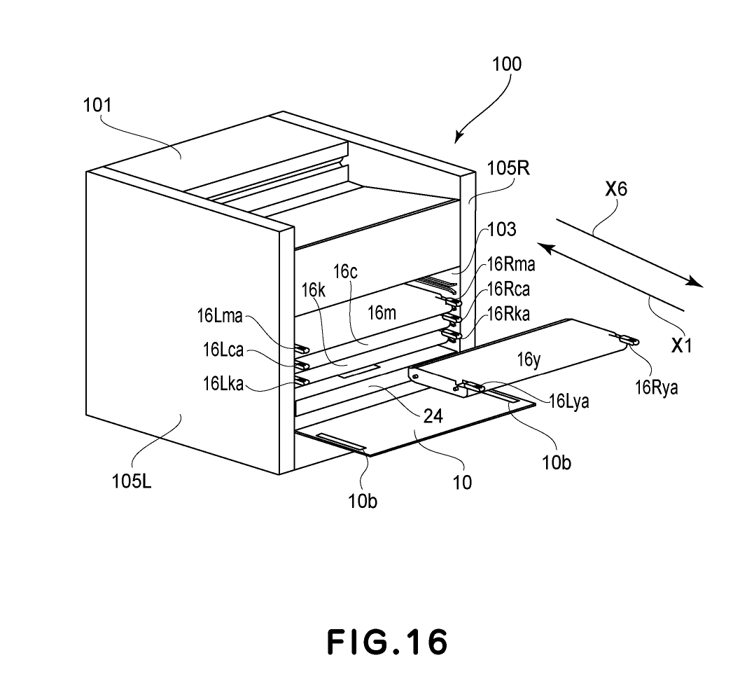

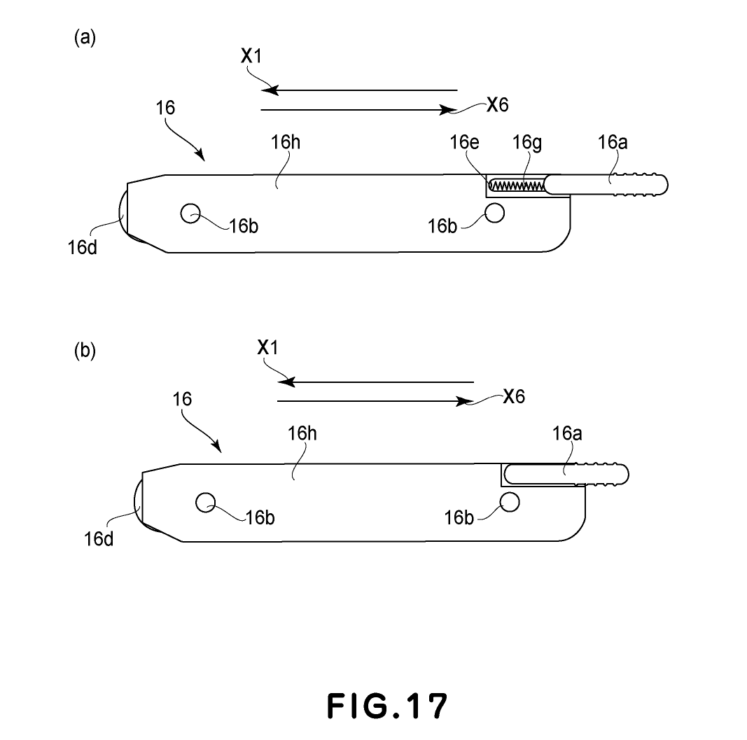

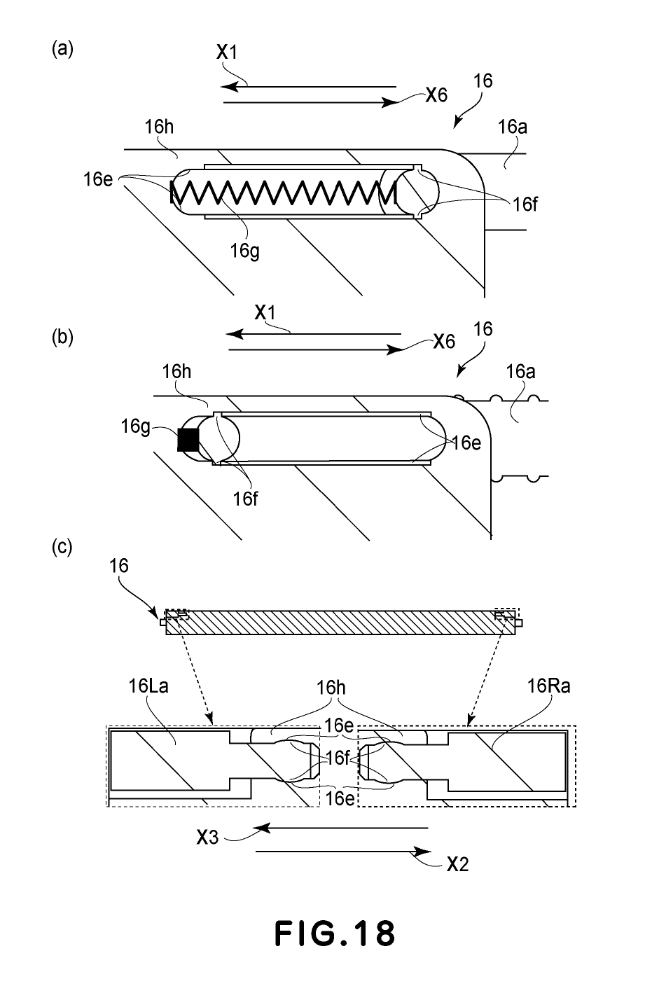

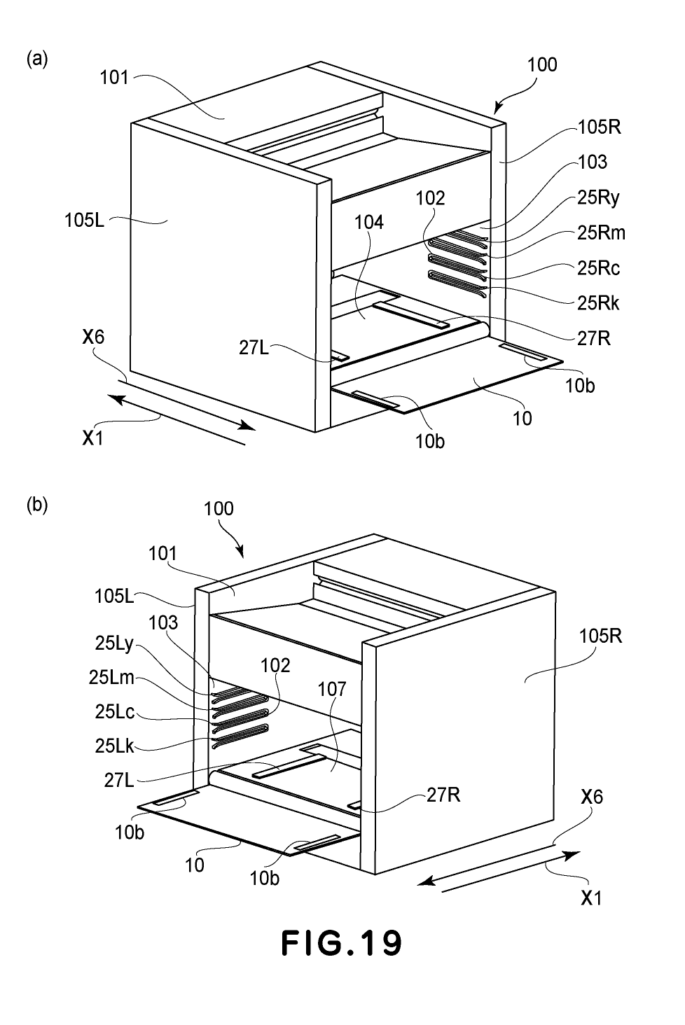

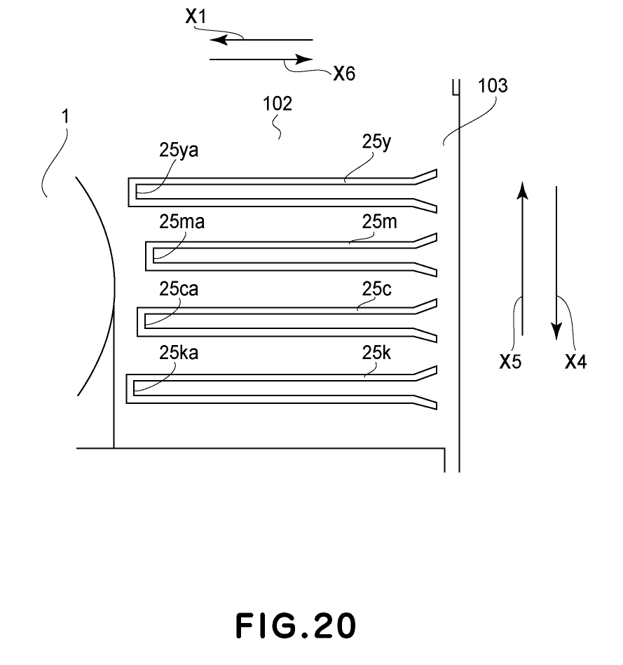

As shown in FIG. 1 and FIG. 4A, an image forming apparatus 100 is a four-color-based full-color laser (beam) printer using an electrophotographic process. That is, the image forming apparatus 100 executes image formation on a sheet-shaped recording material (medium) S on the basis of an electrical image signal inputted from a host device (not shown) such as a personal computer, an image reader or a remote-side facsimile machine into a control circuit portion (not shown).

Here, with respect to the image forming apparatus 100, a front side or a front surface side in a side where a door 10 for opening and closing of the image forming apparatus. A rear side is a side opposite from the front (surface) side. A front-rear direction includes a direction (rearward direction, X1) from the front side to the rear side of the image forming apparatus and a direction (forward direction) opposite to the rearward direction (X1). Left and right (sides) are those when the image forming apparatus 100 is seen from the front side.

Further, a left-right direction includes a direction (rightward direction, X2) from left to right and a direction (leftward direction, X3) opposite to the rightward direction (X2). Upward (above) and downward (below) are those when the image forming apparatus is seen from the front side. Further, an up-down direction includes a direction (downward direction, X4) from above to below and includes a develop (upward direction, X5) from below to above. An image forming apparatus main assembly 101 is an image forming apparatus main assembly portion which is a portion where toner cartridges 8 (8y, 8m, 8c, 8k) are removed from the image forming apparatus 100.

As shown in FIG. 4A, the apparatus main assembly 101 includes photosensitive drums 1 (1y, 1m, 1c, 1k). The photosensitive drums 1 are electrically charged at surfaces thereof by chargers 2 (2y, 2m, 2c, 2k) and are exposed to laser light L, on the basis of image information, by an exposure device 3, so that electrostatic images are formed.

The electrostatic latent images are developed as toner images by developing devices (4y, 4m, 4c, 4k) with toners (developers), of respective colors of yellow, magenta, cyan, black, supplied from toner accommodating portions 5 (5y, 5m, 5c, 5k). The toner images obtained by developing the electrostatic latent images are primary-transferred onto an intermediary transfer belt 12 of an intermediary transfer unit 105. Transfer residual toners remaining on the photosensitive drums 1 after the primary transfer are removed by drum cleaning devices 6 (6y, 6m, 6c, 6k) and then are accommodated in residual toner containers 7 (7y, 7m, 7c, 7k).

On the other hand, a sheet S as a recording material stacked in a feeding cassette 17 is fed to a nip between a secondary transfer roller 13 and the intermediary transfer belt 12 by a feeding roller 18 and a registration roller pair 19, so that the toner images primary-transferred on the intermediary transfer belt 12 are secondary-transferred onto the sheet S. The sheet S on which the toner images are transferred is subjected to fixing of the toner images thereon by a fixing device 20, and then is discharged to an outside of the apparatus main assembly by a discharging roller pair 23. A transfer residual toner remaining on the intermediary transfer belt 12 after the secondary transfer is removed by a belt cleaning device 14, and then is accommodated in a residual toner container 15.

As shown in FIG. 4B, the image forming apparatus 100 in this embodiment includes a toner cartridge mounting portion 11 to which the toner cartridges 8 are mountable. Further, as shown in FIG. 6, the toner cartridges 8y, 8m, 8c, 8k are mounted in the following manner in a state in which a toner cartridge exchange door is opened. That is, the toner cartridges 8 (8y, 8m, 8c, 8k) are detachably (removably) mounted at toner cartridge mounting locations 11a (11ya, 11ma, 11ca, 11ka), respectively, of the mounting portion 11.

Here, the mounting portion 11 is provided on toner moving members 21 (21y, 21m, 21c, 21k) capable of expansion and contraction. In this embodiment, the toner moving members 21 for moving the toner downwardly on the drawing sheet of FIG. 4B expansion and contraction by displacement of the mounting portion 11.

The toner moving members 21 (21y, 21m, 21c, 21k) connect with developer feeding portions (toner feeding portions) 22 (22y, 22m, 22c, 22k), respectively, extending in a vertical direction on the drawing sheet of FIG. 4B. As a result, the toners are moved in the vertical direction on the drawing sheet of FIG. 4B. The toner feeding portions 22 (22y, 22m, 22c, 22k) connect with the toner accommodating portions 5 (5y, 5m, 5c, 5k), respectively, and feed the toners to the toner accommodating portions 5. As a result, the toners (developers) in the toner cartridges 8 can be supplied to developing portions.

### (Structure of Toner Cartridge)

In FIG. 3, (a) and (b) are sectional views each showing the toner cartridge 8. In FIG. 3, (a) shows a state in which the toner cartridge 8 is mounted in the apparatus main assembly 101, and (b) shows a state in which the toner cartridge 8 is demounted from the apparatus main assembly 101.

The toner cartridge 8 includes a toner cartridge casing 8a, an opening 8b, a toner cartridge portion-to-be-engaged 8l, a shutter 8d, and a toner cartridge shutter urging portion 8e. The toner cartridge 8 further includes toner cartridge shutter supporting portion 8f, a toner accommodating portion 8g, an elastic member 8h, a toner seal member 8i, a shutter guide portion 8o and a sheet member 8t.

The toner cartridge 8 is capable of being gripped by holding a portion of the casing 8a. The portion-to-be-engaged 8l is a through hole which is engageable with an engaging portion 11b of the mounting portion in the apparatus main assembly described later and which passes through into the casing 8a. The shutter 8d is guided by the shutter guide portion 8o at the urging portion 8e which is a part thereof, so that the shutter 8d is capable of being displaced in parallel with X4 and X5 directions. At an upper portion of the shutter supporting portion 8f, the shutter supporting portion 8f has a slope so that the toner slips down along the X4 direction by its own weight.

Further, in order to prevent stagnation of the toner, the sheet member 8t is provided on the shutter 8d. The sheet member 8t is constituted by a material capable of being elastically deformed, and a part thereof contacts a lower surface of the supporting portion 8f, and therefore irrespective of movement of the shutter 8d, it is possible to prevent the stagnation of the toner on the shutter 8d.

As shown in (a) of FIG. 3, in a state in which the toner cartridge 8 is mounted in the apparatus main assembly 101, the shutter urging portion 8e is in a state in which the urging portion 8e contacts the engaging portion 11b of the toner cartridge mounting portion 11 which passed through the portion-to-be-engaged 8l and is urged in the X5 direction. Then, the shutter 8d is in a state in which the shutter 8d is displaced in the X5 direction relative to the casing 8a. By this displacement, a gap (spacing) 8u generates, so that the toner accommodated in the toner accommodating portion 8g is supplied to the mounting portion 11.

Further, as shown in (b) of FIG. 3, in a state in which the toner cartridge 8 is a taken out (demounting) from the apparatus main assembly 101, the shutter 8d is in a state in which the shutter 8d is urged in the X4 direction by a spring 8h connected from the shutter supporting portion 8f. In this state, the shutter 8d closes the opening 8, and therefore there is no gap 8u, so that the toner accommodated in the toner accommodating portion 8g is constituted so as not to leak out to an outside of the toner cartridge 8. Here, at a free end of the shutter 8d, the seal member 8i which is elastically deformable is provided, so that the seal member 8i contacts the inside of the casing 8a and closes the opening 8b while partly deforms, and therefore a high sealing property is obtained.

The toner cartridges 8 (8y, 8m, 8c, 8k) are, as shown in FIG. 2, mounted in the listed order from the front side of the apparatus main assembly along X1 direction in a state in which the toner cartridges 8 are mounted into the mounting portion 11. Of these toner cartridges 8, only the toner cartridge 8k is larger in volume of the toner accommodating portion 8kf compared with the toner cartridges for other colors, and also a size thereof is large correspondingly.

### (Structure of Toner Supplying Unit in Apparatus Main Assembly)

As shown in FIG. 4B, the toner supplying unit 104 includes the mounting portion 11, the toner moving members 21 (21y, 21m, 21c, 21k) and the toner feeding portions 22 (22y, 22m, 22c, 22k).

FIG. 5A is a sectional view of the toner supplying unit 104 when the door 9 is opened (in an open state of the mounting portion 11), and FIG. 5B is a sectional view of the toner supplying unit 104 when the door 9 is closed (in a closed state of the mounting portion 11). In FIG. 6, (a) is a sectional view, from a right side direction, of the toner cartridge mounting portion 11 in a state in which the toner cartridges 8 (8y, 8m, 8c, 8k) are demounted, and (b) is an enlarged view of the mounting location 11a of the toner cartridge mounting portion 11.

### 1) Mounting Portion

As shown in (a) of FIG. 6, at the mounting portion 11, 4 mounting locations 11a (11ya, 11ma, 11ca, 11ka) are provided in the listed order along the X1 direction so that the toner cartridges 8 (8y, 8m, 8c, 8k) are mountable.

At bottoms 11d (11yd, 11md, 11cd, 11kd) of the mounting portion 11a, the toner cartridge engaging portions 11b (11yb, 11mb, 11cb, 11kb) are provided, respectively. Further, toner discharge openings 11c (11yc, 11mc, 11cc, 11kc) are provided. As shown in FIG. 3, when the toner cartridges 8 are mounted into the mounting locations 11a along the X4 direction, the engaging portions 11b engage with the portion-to-be-engaged 8l (81yl, 81ml, 81cl, 81kl).

Then, when the toner cartridges 8 are further mounted into the mounting locations 11a, the engaging portions 11b penetrate through the portion-to-be-engaged 8l and are contactable to the shutters 8 (8yd, 8md, 8cd, 8kd). Further, a size of each of the engaging portions 11b with respect to the X5 direction is not particularly limited, but may only be required to be as shown in (a) of FIG. 3. That is, in a state in which the engaging portion 11b and the portion-to-be-engaged 8l of the toner cartridge 8 are sufficiently engaged with each other, the size of the engaging portion 11b may only be required to be a length in which the engaging portion 11b is capable of pushing up the shutter 8d in the X5 direction to the extent that the gap 8u capable of permitting movement of the toner from the toner accommodating portion 8g toward the opening 8b generates.

Incidentally, in (a) of FIG. 3, engagement between the engaging portion 11b and the portion-to-be-engaged 8l is made by a snap-fit mechanism (constitution in which a projected portion of one of the portions is engaged in and hooked in a recessed portion of the other portion by using elasticity of materials). That is, the toner cartridge 8 can be sufficiently mounted into the mounting location 11a by applying a certain force or more in the X4 direction.

Further, in FIG. 6, each of the toner discharge openings 11c has a constitution provided with a slope with respect to the X4 direction, so that the toner easily drops through the toner discharge opening 11c. Further, in FIG. 5A, on each of the right side and the left side of the mounting portion 11, an end portion 11e is provided. Under the end portion 11e, an elastic member 27 as an expansion and contraction member is provided, and an opposite end portion of the elastic member 27 is connected with a supporting portion 24 for the mounting portion. For that reason, the mounting portion 11 is always in a state in which the mounting portion 11 is urged from the supporting portion 24 in the X5 direction through the elastic member 27.

Further, the end portion 11e also functions as a portion-to-be-guided relative to the apparatus main assembly 101. For that reason, the mounting portion 11 is capable of being displaced in a direction parallel to the X4 and X5 directions. The apparatus main assembly 101 is provided with displacement limiting portions 25, 26 for limiting the displacement of the mounting portion 11. The mounting portion 11 is capable of being displaced in the X4 direction to a contact position with the displacement limiting portion 25 and is capable of being displaced in the X5 direction to a contact position with the displacement limiting portion 26.

### 2) Toner Among Member 21

As shown in FIG. 4B, the toner moving members 21 (21y, 21m, 21c, 21k) are provided between the mounting portion 11 and the toner feeding portions 22 (22y, 22m, 22c, 22k). Upon surfaces of the toner moving members 21 are in a contact state with a lower surface of the mounting portion 11, and lower surfaces of the toner moving members 21 are in a contact state with upper surfaces of the toner feeding portions 22.

The toner moving member 21 is, as shown in FIGS. 5A and 5B, constituted by a bellow material capable of expansion and contraction in a certain amount, and thus has a bellow shape, so that the toner moving member 21 has a constitution in which the mounting portion 11 contracts in accordance with movement thereof in the X4 direction and expands in accordance with movement thereof in the X5 direction.

Further, the toner moving members 21 are provided with toner drop openings 21a (21ya, 21ma, 21ca, 21ka) at insides thereof, so that the toner can be dropped in the X4 through each of the toner drop openings 21a.

Further, the toner moving members 21 are disposed so that the toner discharge openings 11c of the mounting portion 11, the toner drop openings 21a and toner receiving openings 22a (22ya, 22ma, 22ca, 22ka) of the toner feeding portions 22 overlap with each other with respect to the X4 direction. For this reason, the toner can be dropped from the mounting portions 11 to the toner feeding portions 22.

Incidentally, lengths of the toner moving members 21 with respect to the X4 direction are made by different depending on associated colors of the toners.

### 3) Toner Feeding Portion 22

As shown in FIGS. 5A and 5B, each of the toner moving members 22 is provided with the toner receiving opening 22a at an upper portion thereof, so that the toner is fed into the toner feeding portion 22 through the toner receiving opening 22a. Further, the toner feeding portion 22 is connected with the toner accommodating portion 5, and the toner is fed to the toner accommodating portion 5 by an inside screw (not shown).

### (Structure of Door for Apparatus Main Assembly)

At an upper surface of the door 9 in a position shown in FIG. 1, a handle 9a is provided, and a user holds the handle 9a to open and close the door 9, so that the door 9 rotates about a hinge shaft (not shown). FIG. 1 shows a closed state of the door 9, and FIG. 2 shows an open state of the door 9.

As shown in FIG. 2, at a lower surface of the door 9, toner cartridge urging portions 9b (9yb, 9mb, 9cb, 9kb) are provided. Each of the urging portions 9b has an arcuate shape as seen from a side surface, but may also have another shape if the urging portion 9b is capable of smoothly contact the toner cartridge 8. The urging portion 9b may also be constituted by an elastically deformable material so as not to break the toner cartridge 8 when the door 9 is closed and the urging portion 9b contacts the toner cartridge 8.

### (During Mounting of Toner Cartridge)

In FIG. 2, (b) shows a state before the toner cartridge 8y is mounted into the apparatus main assembly 101. In a state in which the door 9 is sufficiently opened, the toner cartridge 8y can be mounted into the mounting location 11ya of the mounting portion 11 in parallel to the X4 direction. In the following, using FIG. 3 and (b) of FIG. 6, mounting of the toner cartridge 8 will be described. Incidentally, in this embodiment, a mounting method of the toner cartridge 8y is shown, but other toner cartridges 8m, 8c, 8k can also be similarly mounted.

When the toner cartridge 8 is mounted into the mounting location 11a along the X4 direction, in a state in which the toner cartridge 8 is mounted in a certain amount or more, the engaging portion 11b of the mounting portion 11 and the portion-to-be-engaged 8l of the toner cartridge 8 start to contact and engage with each other. After the engagement, when the toner cartridge 8 is further pushed into the mounting location 11a in the X4 direction, the portion-to-be-engaged 8l reaches an inside of the casing 8a. At this time, the engaging portion 11b which reached the inside of the casing 8a and the lower surface of the shutter urging portion 8e are in contact with each other. When the engaging portion 11b is further inserted into the inside of the casing 8a, the shutter urging portion 8e is correspondingly pushed up in the X5 direction.

Then, when the toner cartridge 8y is sufficiently mounted to the mounting location 11a, as shown in (a) of FIG. 3, the shutter 8d is sufficiently pushed up in the X5 direction and the gap 8u generates between the shutter 8d and the casing 8a, with the result that the toner is discharged to the outside of the toner cartridge 8y through the opening 8b. As a result, the toner is supplied from the toner cartridge 8 to an inside of the toner supplying unit 104 of the apparatus main assembly 101. A sectional view of the apparatus main assembly 101 in a state in which this operation is performed for the toner cartridges 8 for all of the colors and in which the toner cartridges 8 are sufficiently mounted to the mounting portion 11 and then the door 9 opens is shown in FIG. 5A.

Here, in a state in which the mounting of all of the toner cartridges 8 to the mounting portion 11 is completed (FIG. 5A), the door 9 is gradually closed while gripping the handle 9a of the door 9. When the door 9 is closed to some extent, the urging portions 9b of the door 9 and the upper portions of the toner cartridges 8 in the mounted state to the mounting locations 11 contact each other. Further, when the door 9 is further closed, the urging portions 9b urge the toner cartridges 8 in the X4 direction. Irrespective of sufficient mounting and insufficient mounting of the toner cartridges 8 to the mounting portion 11, as the toner cartridges 8 are urged, also the mounting portion 11 is urged in the X4 direction, so that both of the toner cartridges 8 and the mounting portion 11 are gradually displaced in the X4 direction.

Then, in association with the door 9, when the mounting portion 11 is displaced in the X4 direction to a predetermined position, the lower surface of the mounting portion 11 contacts the displacement limiting portions 25. By this contact, the displacement of the mounting portion 11 in the X4 direction stops. In this state in which the toner cartridges 8 are sufficiently mounted to the mounting portion 11, as shown in FIG. 5B, the door 9 is closed in a state in which the urging portions 9b and the upper surfaces of the toner cartridges 8 are in contact with each other and in which the mounting portion 11 and the displacement limiting portions 25 are in contact with each other. At this time, the apparatus main assembly 101 is in an image formable state.

Further, in a state in which the toner cartridges 8 are not sufficiently mounted to the mounting portion 11, the door 9 is rotated in a closing direction from a state in which the toner cartridges 8 contact the urging portions 9b of the door 9 and in which the mounting portion 11 contacts the displacement limiting portions 26. As a result, the urging portions 9b gradually push the toner cartridges 8 in the X4 direction, and the door 9 is sufficiently closed, so that as shown in FIG. 5B, the toner cartridges 8 are in a state in which the toner cartridges 8 are sufficiently mounted to the mounting portion 11. Incidentally, when the door 9 is closed, the door 9 receives an urging force in the X5 direction from the elastic members 27 through the mounting portion 11, and therefore there is a need to apply a certain force or more.

### (During Demounting of Toner Cartridge)

Next, a state in which the toner cartridge 8y is demounted from the apparatus main assembly 101 will be described. In this step, the above-described mounting process of the toner cartridge 8y into the apparatus main assembly 101 is reversely performed. In this embodiment, a demounting method of the toner cartridge 8y is shown, but other toner cartridges 8m, 8c, 8k can also be similarly demounted.

Before the toner cartridges 8 are exchanged, as shown in FIG. 5B, the apparatus main assembly 101 is in an image formable state. In this state, the mounting portion 11 receives a force for urging the mounting portion 11 in the X5 direction from the elastic members 27 through the end portions 11e. However, a force, for urging the mounting portion 11 in the X4 direction, received by the mounting portion 11 from the urging portions 9b of the door 9 through the cartridges 8 is large, and therefore the mounting portion 11 is in a state in which the mounting portion 11 does not move.

From this state, when the handle 9a is held and the door 9 is opened gradually, the urging force exerted from the elastic member 27 on the mounting portion 11 in the X5 direction is unchanged, but the influence of the urging portions 9b gradually decreases. For that reason, with an opening operation of the door 9, the mounting portion 11 is displaced correspondingly to a certain distance in the X5 direction in a state in which either of the toner cartridges 8 contacts the associated urging portion(s) 9b. After the door 9 is opened to some extent or more, when the contact between the toner cartridges 8 and the urging portions 9b is eliminated, the mounting portion 11 is further displaced in the X5 direction in a certain amount.

After the mounting portion 11 is displaced in the X5 direction in the certain amount, the upper surfaces of the end portions 11e of the mounting portion 11 contact the displacement limiting portions 26. By this contact, the development of the mounting portion 11 in the X5 direction stops, so that the mounting portion 11 is in a state shown in FIG. 5A. Incidentally, when the door 9 is changed from the closed state to the open state quickly, also the mounting portion 11 quickly moves form a position of FIG. 5B to a position of FIG. 5A. Also at this time, the engaging portions 11b of the mounting portion 11 and the portions-to-be-engaged 8l of the toner cartridges 8 are in an engaged state, and therefore the toner cartridges 8 are not demounted from the mounting portion 11 and also the toner is not leaked out to the outside of the toner cartridges 8. This state in which the door 9 is sufficiently opened is shown in (b) of FIG. 2.

Thus, in the state in which the door 9 is opened, the toner cartridge 8y is gradually demounted in parallel to the X5 direction. At this time, as shown in FIG. 5A, the mounting portion 11 and the toner cartridges 8 are in a state (projected state) in which these portions (members) project from an outer configuration of the apparatus main assembly 101 to the outside of the toner cartridges 8. For this reason, the user can demounts the toner cartridges 8 with reaching into the apparatus main assembly 101 with hand.

A state before the toner cartridges 8 are demounted from the mounting portion 11 is, as shown in (a) of FIG. 3 and FIG. 5A, in such a state that the engaging portions 11b penetrate through the portions-to-be-engaged 8l of the toner cartridges 8 and push up the shutters 8d in the X5 direction. From this state, when the toner cartridges 8 are pulled out in the X5 direction, the shutter urging portions 8e are gradually moved away from the engaging portions 11b, and therefore an amount of contraction of the springs 8h connecting the shutters 8d and the toner cartridge supporting portions 8f becomes small.

As a result, the springs 8h expand in the X4 direction, and also the shutters 8d are displaced in the X4 direction, so that the gaps 8u gradually narrow (close). Then, when the toner cartridges 8 are gradually demounted along the X5 direction, contact between the engaging portions 11b and the shutter urging portions 8e is eliminated and the shutters 8d return to predetermined positions, so that a state in which the gaps 8u are eliminated is formed and a state in which the openings 8b are sufficiently closed is formed. As a result, when the toner cartridges 8 are taken out to the outside of the apparatus main assembly 101, it is possible to prevent the toners inside the casings 8a from leaking out to the outside of the casings 8a.

Thereafter, when the toner cartridges 8 are further be mounted in the X5 direction, also engagement between the engaging portions 11b and the portions-to-be-engaged 8l is eliminated (disengaged), so that the toner cartridges 8 are in the state shown in FIG. 5B. Then, finally, as shown in FIG. 6, the toner cartridges 8 can be sufficiently demounted from the mounting locations 11a.

### Second Embodiment

Similarly as in First Embodiment, also in this embodiment, the door 9 is provided. Different from First Embodiment, in this embodiment, a constitution in which in interrelation with the opening and closing of the door 9, only the grip portions of the toner cartridges are displaced but the mounting portion (toner cartridge mounting portion) is not displaced (i.e., is kept at the predetermined position) is employed.

### (Structure of Toner Cartridge)

Each of (a) and (b) of FIG. 10 and (b) of FIG. 11 is a sectional view of a toner cartridge 8 in this embodiment. In FIG. 10, (a) is the sectional view showing a state in which the toner cartridge 8 is mounted in the apparatus main assembly 101 and the door 9 is open, and (b) is the sectional view showing a state in which the toner cartridge 8 is mounted in the apparatus main assembly 101 and the door 9 is closed. Further, (b) of FIG. 11 is the sectional view showing a state in which the toner cartridge 8 is demounted from the apparatus main assembly 101.

The toner cartridge 8 includes a casing 8a, an opening 8b, a portion-to-be-engaged 8l, a shutter 8d, a toner cartridge shutter urging portion 8e, shutter supporting portion 8f, a toner accommodating portion 8g, elastic members 8h, 8g as expansion and contraction members and a toner seal member 8. The toner cartridge 8 further includes a toner cartridge grip portion 8j, a grip portion accommodating portion 8n, a shutter guide portion 8o, a sheet member 8t and a grip portion contact portion 8s.

The portion-to-be-engaged 8l is a through hole which is engageable with an engaging portion 11b and which passes through into the casing 8a. Further, at an upper portion of the shutter supporting portion 8f, a sufficient slope relative to the X4 direction is provided so that the toner can slip down.

With respect to the toner cartridge 8, the user is capable of performing a demounting operation while gripping the grip portion 8j. The grip portion 8j is provided with an upper grip portion 8r and a lower grip portion 8p, and the elastic member 8q contacts a lower surface of the lower grip portion 8p. The elastic member 8q is an urging spring and is provided above the shutter supporting portion 8f. For that reason, in a state in which an external force exerted on the grip portion 8j in the X4 direction does not generate, as shown in (a) of FIG. 10, the grip portion 8j is disposed at a second position where the grip portion 8j is pushed up in the X5 direction. At this time, by contact of the lower grip portion 8p with the casing 8a, the grip portion 8j is limited so that the grip portion 8j cannot move further in the X5 direction.

Further, in a state in which the external force exerted on the grip portion 8j in the X4 direction generates, as shown in (b) of FIG. 10, the grip portion 8j is urged in the X4 direction, so that the grip portion 8j is disposed at a first position where the grip portion 8j is accommodated in the grip portion accommodating portion 8n and the image is formable. At this time, the elastic member 8q is in a contracted state by the external force. Further, by contact of the lower grip portion 8p with the grip portion contact portion 8s, so that the grip portion 8j is limited so that the grip portion 8j cannot move further in the X4 direction. When this grip portion 8j moves in the grip portion accommodating portion 8n, a part of the toner cartridge casing 8a constitutes a guide, so that the grip portion 8j can move in parallel with the X4 direction or the X5 direction.

The shutter 8d is guided by the shutter guide portion 8o at the shutter urging portion 8e which is a part thereof, so that the shutter 8d is capable of being moved in parallel with X4 and X5 directions. When the shutter 8d moves, in order to prevent stagnation of the toner, the sheet member 8t is provided on the shutter 8d. The sheet member 8t is constituted by a material capable of being elastically deformed, and a part thereof always contacts a lower surface of the supporting portion 8f. For that reason, irrespective of movement of the shutter 8d, it is possible to prevent the stagnation of the toner on the shutter 8d.

As shown in (b) of FIG. 3, in a state in which the toner cartridge 8 is a taken out (demounting) from the apparatus main assembly 101, the shutter 8d is in a state in which the shutter 8d is urged in the X4 direction by a spring 8h connected from the shutter supporting portion 8f. In this state, the shutter 8d closes the toner cartridge opening 8, and therefore there is no gap 8u between the shutter 8d and the casing 8a, so that the toner accommodated in the toner accommodating portion 8g is constituted so as not to leak out to an outside of the toner cartridge 8. Here, at a free end of the shutter 8d, the seal member 8i which is elastically deformable is provided, so that the seal member 8i contacts the casing 8a and closes the toner cartridge opening 8b while partly deforms, and therefore a high sealing property is obtained.

Further, as shown in (a) and (b) of FIG. 10, in a state in which the toner cartridge 8 is sufficiently mounted into the apparatus main assembly 101, the shutter urging portion 8e contacts the engaging portion 11b, of the mounting portion 11, penetrating through the portion-to-be-engaged 8l and thus is in an urged state in the X5 direction. Then, the shutter 8d is in a state in which the shutter 8d moves in the X5 direction relative to the toner cartridge casing 8a. By this movement, the gap 8u generates between the shutter 8d and the casing 8a, so that the toner accommodated in the accommodating portion 8g is supplied to the mounting portion 11.

Here, as shown in FIG. 9A, the grip portions 8j (8yj, 8mj, 8cj, 8kj) are different in length with respect to the X5 direction for each of colors. This is because lengths of the grip portions 8j are different with respect to the X5 direction when the toner cartridges 8 are mounted into the mounting portions 11 are different but when the door 9 is opened and the grip portions 8j are moved from the first position to the second position, the grip portions 8j are placed in a substantially aligned state (in which end positions of the grip portions 8j are aligned with a predetermined (horizontal) surface).

Incidentally, this aligned state is not required to be substantially the same level (height) with respect to the X5 direction, but may only be required that a difference in height of the grip portions 8j with respect to the X5 direction is smaller than a difference in height of the toner cartridges 8 with respect to the X5 direction when the toner cartridges 8 are mounted into the mounting portions 11.

Further, by the difference in length of the grip portions 8j with respect to the X5 direction, even when the user inserts the toner cartridge 8 into an erroneous mounting portion 11, the door 9 cannot be closed, and therefore erroneous mounting of the toner cartridge 8 can be prevented.

Incidentally, as shown in FIG. 8, the toner cartridges 8 are mounted in the order of 8y, 8m, 8c, 8k from the front side of the apparatus main assembly along X1 direction in a state in which the toner cartridges 8 are mounted into the mounting portion 11. Of these toner cartridges 8, only the toner cartridge 8k is larger in volume of the toner accommodating portion 8kf compared with the toner cartridges for other colors, and therefore a shape thereof is large as shown in FIGS. 9A and 9B.

However, the toner cartridge increased in volume and size is not limited to the toner cartridge 8k, but may also be another toner cartridge or other toner cartridges for a plurality of colors. Further, the order of arrangement of the toner cartridges 8 into the apparatus main assembly 101 may also be the order different from the order of 8y, 8m, 8c, 8k from the front side along the X1 direction.

### (Structure of Toner Supplying Unit in Apparatus Main Assembly)

As shown in FIG. 7B, the toner supplying unit 104 includes the mounting portions 11 (11y, 11m, 11c, 11k), the toner moving members 21 (21y, 21m, 21c, 21k) and the toner feeding portions 22 (22y, 22m, 22c, 22k).

FIG. 9A is a sectional view of the toner supplying unit 104 when the door 9 is opened, and FIG. 9B is a sectional view of the toner supplying unit 104 when the door 9 is closed. As shown in FIGS. 9A and 9B, mounting positions of the plurality of toner cartridges 8 are different from each other with respect to a mounting direction (for example, a vertical direction) common to the plurality of toner cartridges 8. In FIG. 12, (a) is a sectional view, from a right side direction, of the toner cartridge mounting portion 11 in a state in which the toner cartridges 8 (8y, 8m, 8c, 8k) are demounted, and (b) is an enlarged view of the mounting location 11a of the toner cartridge mounting portion 11.

As shown in (a) of FIG. 12, at the mounting portions 11, mounting locations 11a (11ya, 11ma, 11ca, 11ka) are provided in the listed order along the X1 direction so that the toner cartridges 8 are mountable. Further, the 4 mounting portions 11 are disposed and shifted with respect to the X4 direction, and correspondingly also the mounting locations 11a are disposed and shifted with respect to the X5 direction. Incidentally, in this embodiment, the mounting location 11ya is disposed at a highest position with respect to the X5 direction and the mounting location 11ka is disposed at a lowest position with respect to the X5 direction, but different mounting locations may also be disposed at the highest position or the lowest position.

At bottoms 11d (11yd, 11md, 11cd, 11kd) of the mounting portion 11a, the toner cartridge engaging portions 11b (11yb, 11mb, 11cb, 11kb) are provided, respectively. Further, toner discharge openings 11c (11yc, 11mc, 11cc, 11kc) are provided.

When the toner cartridges 8 are mounted into the mounting locations 11a along the X4 direction, the engaging portions 11b engage with the portion-to-be-engaged 8l (81yl, 81ml, 81cl, 81kl). Then, when the toner cartridges 8 are further mounted into the mounting locations 11a, the engaging portions 11b penetrate through the portion-to-be-engaged 8l and are contactable to the toner cartridge shutters 8 (8yd, 8md, 8cd, 8kd).

Further, a size of each of the engaging portions 11b with respect to the X5 direction is not particularly limited, but may only be required to be constituted in the following manner. That is, as shown in (a) of FIG. 10, in a state in which the engaging portion 11b and the portion-to-be-engaged 8l of the toner cartridge 8 are sufficiently engaged with each other, the size of the engaging portion 11b may only be required to be a length in which the engaging portion 11b is capable of pushing up the shutter 8d in the X5 direction to the extent that the gap 8u capable of permitting movement of the toner from the toner accommodating portion 8g toward the opening 8b generates.

Incidentally, a portion of engagement between the engaging portion 11b and the portion-to-be-engaged 8l has a snap-fit constitution, so that, the toner cartridge 8 can be sufficiently mounted into the mounting location 11a by applying a certain force or more in the X4 direction. Further, as shown in FIG. 9A, each of the toner discharge openings 11c has a constitution provided with a slope with respect to the X4 direction, so that the toner easily drops through the toner discharge opening 11c.

As shown in FIGS. 9A and 9B, the toner moving members 21 are provided between the mounting portions 11 and the toner feeding portions 22. Upon surfaces of the toner moving members 21 are in a contact state with a lower surface of the mounting portion 11, and lower surfaces of the toner moving members 21 are in a contact state with upper surfaces of the toner feeding portions 22.

The toner moving members 21 are provided with toner drop openings 21a (21ya, 21ma, 21ca, 21ka) at insides thereof, so that the toner can be dropped in the X4 through each of the toner drop openings 21a.

Here, the toner discharge openings 11c of the mounting portion 11, the toner drop openings 21a of the toner moving members 21 and toner receiving openings 22a (22ya, 22ma, 22ca, 22ka) of the toner feeding portions 22 are provided so as to overlap with each other with respect to the X1 direction. For this reason, the toner can be dropped from the mounting portions 11 to the toner feeding portions 22. Incidentally, lengths of the toner moving members 21 with respect to the X4 direction are made by different depending on associated colors of the toners.

As shown in FIGS. 9A and 9B, each of the toner moving members 22 is provided with the toner receiving opening 22a at an upper portion thereof, so that the toner is fed into the toner feeding portion 22 through the toner receiving opening 22a. Further, the toner feeding portion 22 is connected with the toner accommodating portion 5, and the toner is fed to the toner accommodating portion 5 by an inside screw (not shown).

### (Structure of Door for Toner Cartridge Exchange)

A door 9 in this embodiment is similar to the door 9 in First Embodiment. That is, as shown in FIG. 1, at an upper surface of the door 9, a handle 9a is provided. A user holds the handle 9a to open and close the door 9, so that the door 9 rotates about a hinge shaft (not shown), and thus the door 9 can be placed in a closed state as shown in FIG. 1 or in an open state as shown in FIG. 8.

As shown in FIG. 8, FIG. 9B and (a) of FIG. 11, at a lower surface of the door 9, grip portion urging portions 9b (9yb, 9mb, 9cb, 9kb) are provided. Each of the urging portions 9b has a rectangular shape as seen from a right side direction or a front surface direction, but may also have another shape if the urging portion 9b is capable of smoothly contact the toner cartridge 8.

The grip portion urging portion 9b may also be constituted by an elastically deformable material so as not to break the toner cartridge 8 when the door 9 is closed and the urging portion 9b contacts the toner cartridge 8. Incidentally, when the inner surface of the door 9 is constituted by a material capable of absorbing an impact and a contact noise at the time of contact thereof with the grip portions 8j (8yj, 8mj, 8cj, 8kj), the grip portion urging portions 9b may also be not disposed, but the door 9 may directly contact the grip portions 8j.

### (During Mounting of Toner Cartridge)

A state before the toner cartridge 8y is mounted into the apparatus main assembly 101 is shown in (a) of FIG. 11. In a state in which the door 9 is sufficiently opened, the toner cartridge 8y can be mounted into the mounting location 11ya of the mounting portion 11 in parallel to the X4 direction. In the following, using (a) and (b) of FIG. 10 and (b) of FIG. 12, mounting of the toner cartridge 8 will be described.

The user grips the grip portion 8j and gradually inserts the toner cartridge 8 into the mounting location 11a ((b) of FIG. 12). When the toner cartridge 8 is inserted to a certain degree or more, the portion-to-be-engaged 8l and the engaging portion 11b are in contact with each other, and therefore the user removes his (her) hand in that state. In this contact state, even when the user removes his (her) hand, the engaging portion 11b and the portion-to-be-engaged 8l have a constitution in which these portions are engaged with each other in a snap-fit shape, and therefore are not sufficiently engaged with each other in a state in which an external force does not generate with respect to the X4 direction.

All of the toner cartridges 8 are placed in the mounted state into the mounting portions as described above, and then the door 9 is gradually closed. In this state, the grip portions 8j are disposed at the second position. When the door 9 is closed to a certain degree or more, the grip portion urging portions 9b contact the upper surfaces of the upper grip portions 8r of the grip portions 8y of the toner cartridges 8. From that state, when the door 9 is further closed, the external force exerted on the grip portions 8j generates with respect to the X4 direction, so that the external force is transmitted to the elastic members 8q through the grip portions 8j. By this external force, the elastic members 8q are elastically deformed and start to contrast.

When each of the elastic members 8q contracts to some extent or more, the portion-to-be-engaged 8l and the engaging portion 11b start to engage each other. When the door 9 is further closed, the portion-to-be-engaged 8l and the engaging portion 11b sufficiently engage with each other, so that the portion-to-be-engaged 8l penetrates through the casing 8a, and contacts the shutter urging portion 8e for the shutter 8d provided inside the casing 8a. From this state, when the grip portion 8j is further pushed in, simultaneously with further contraction of the elastic member 8q, the external force is transmitted to the elastic member 8q through the shutter urging portion 8e, and therefore also the elastic member 8h starts to contract. As a result, the shutter 8d starts to move in the X5 direction relative to the casing 8a.

Then, in a state in which the door 9 is sufficiently closed, as shown in (b) of FIG. 10, the elastic member 8q is pushed down until the lower grip portion 8q of the grip portion 8j is in a contact state with the grip portion contact portion 8s. Thus, the grip portion 8j is in a state in which the grip portion 8j is disposed at the first position where the grip portion 8j is accommodated sufficiently in the grip portion accommodating portion 8n. Further, the elastic member is pushed up with an increasing degree of the gap 8u from the casing 8a, the shutter 8d is in a moved state.

By the generation of the gap 8u as described above, the toner passes from the toner accommodating portion 8g of the toner cartridge 8 through the gap 8u and the opening 8b, so that the toner is capable of being supplied to the outside of the toner cartridge 8. In this state, mounting of the toner cartridge 8 into the mounting portion 11a is completed, so that the image forming apparatus 100 is capable of forming the image.

Incidentally, in this embodiment, an example in which when the user closes the door 9, the toner cartridge 8 is sufficiently mounted, from such an insufficient mounted state that the toner cartridge 8 is only placed on the mounting portion 11a, by a closing operation of the door 9 was shown. Here, even when the user pushes in the grip portion 8j and then pushes in the door 9 from the sufficiently engaged state between the engaging portion 11b and the portion-to-be-engaged 8l, the toner cartridge 8 can also be placed similarly in the sufficiently mounted state. Further, in the constitution in this embodiment, in order to mount the toner cartridge 8 into the mounting portion 11a, there is a need to apply a certain external force or more for placing the toner cartridge 8 in the sufficiently mounted state by closing the door 9 to cause the grip portion 8j to be urged by the elastic members 8h and 8q in the X5 direction.

### (During Demounting of Toner Cartridge)

Next, a state in which the toner cartridge 8 is demounted from the apparatus main assembly 101 will be described. In this step, the above-described mounting process of the toner cartridge 8 into the apparatus main assembly 101 is reversely performed.

Before the toner cartridge 8 is exchanged, as shown in (b) of FIG. 10, the toner cartridge 8 is sufficiently mounted into the mounting portion 11, and the image forming apparatus 100 is in an image formable state. The external force exerted on the door 9 generates with respect to the X5 direction from the elastic members 8q (8yq, 8mq, 8cq, 8kq) through the grip portions 8j, but a force for closing the door 9 is larger than the external force, and therefore the door 9 is in a sufficiently closed state. Further, the grip portions 8j are in a state in which the grip portions 8j are disposed at the first position where the grip portions 8j are urged by the door 9 and are accommodated inside the apparatus main assembly.

From this state, when the user holds the handle 9a and gradually opens the door 9, the elastic member 8q returns to a natural length, and therefore in a state in which the grip portion 8j contacts the grip portion urging portion 9b ((b) of FIG. 10), the elastic member 8q starts to expand in the X5 direction. When the door 9 is opened to a certain degree or more from the contact state, the upper portion 8r of the toner cartridge grip portion 8j is spaced from the grip portion urging portion 9b ((b) of FIG. 10).

Then, as shown in (a) of FIG. 10, the lower portion 8p of the grip portion 8j is in a contact state with the casing 8a, and therefore at least a part of the toner cartridge 8 mounted into the mounting portion 11 is in the second position (maximum expansion position of the elastic member 8q) where the part is exposed (projected) to the outside of the apparatus main assembly.

Incidentally, also in a state in which the door 9 is opened, the portion-to-be-engaged 8l of the toner cartridge 88 and the engaging portion 11b of the mounting portion 11 are in the engaged state by snap fitting. For this reason, the elastic member 8h is kept in an urged state in the X4 direction, and the door 9 is displaced in the X5 direction relative to the casing 8a similarly as in the case before the door 9 is opened, so that also the gap 8u is generated.

Further, when the user grips the grip portion 8j and gradually takes out the toner cartridge 8 in the X5 direction, the shutter urging portion 8e of the toner cartridge 8 is gradually spaced from the engaging portion 11b of the mounting portion 11.

For this reason, an amount of contraction of the elastic member 8h connecting the shutter 8d and the toner cartridge supporting portion 8f becomes small.

As a result, the elastic member 8h expands in the X4 direction, and also the shutter 8d is moved in the X4 direction relative to the casing 8a, so that the gap 8u gradually narrows (closes).

Then, when the toner cartridge 8 is gradually demounted along the X5 direction, contact between the engaging portion 11b and the shutter urging portion 8e is eliminated and the shutter 8d returns to a predetermined position, so that a state in which the gap 8u is eliminated is formed and a state in which the toner cartridge opening 8b is sufficiently closed is formed. As a result, when the toner cartridge 8 is taken out to the outside of the apparatus main assembly 101, it is possible to prevent the toner inside the toner cartridge casing 8a from leaking out to the outside of the casing 8a.

Thereafter, when the toner cartridge 8 is further be mounted in the X5 direction, also engagement between the engaging portion 11b and the portion-to-be-engaged 8l is eliminated (disengaged), so that the toner cartridge 8 can be sufficiently demounted from the mounting location 11a.

### Third Embodiment

An image forming apparatus 100 in this embodiment are shown in FIGS. 13A and 13B. First and Second Embodiments relates to the type in which the toner cartridges were exchanged, but this embodiment relates to a type in which developing cartridges as developing devices including developing rollers are exchanged. Further, in this embodiment, similarly as in Second Embodiment, a constitution in which in interrelation with the opening and closing of the door, only the grip portion of the cartridge is displaced but the mounting portion (cartridge mounting portion) is not displaced is employed. An apparatus main assembly 101 in this embodiment is a portion obtained by removing a drum cartridge 24 and developing cartridges 16 (16y, 16m, 16c, 16k) from the image forming apparatus 100.

As shown in FIG. 13A, a constitution in which an image is formable in a state in which the drum cartridge 24 and the developing cartridges 16 are mounted in the apparatus main assembly 101 is employed. The drum cartridge 24 includes a photosensitive drum 1, a charger 2, a drum cleaning device 6 and a residual toner container 7. The photosensitive drum 1 is electrically charged at a surface thereof by the charger 2 and is exposed to laser light L, on the basis of image information, by an exposure device 3, so that electrostatic images are formed.

The electrostatic latent images are developed as toner images by developing rollers 16d (16yd, 16md, 16cd, 16kd) of the developing cartridges 16 which are the developing devices with toners, of respective colors of yellow, magenta, cyan, black, supplied from toner accommodating portions 5 (not shown). The toner images obtained by developing the electrostatic latent images are primary-transferred onto an intermediary transfer belt 12 of an intermediary transfer unit 105. Transfer residual toners remaining on the photosensitive drum 1 after the primary transfer are removed by the drum cleaning device 6 and then are accommodated in the residual toner container 7.

### (Exchange of Developing Cartridge)

A left side view of the developing cartridges 16 when no external force exerted on the developing cartridges 16 generates is shown in each of FIG. 15A and (a) of FIG. 17. Each of the developing cartridges 16 is constituted by a casing 16h, a portion-to-be-guided 16b, the developing roller 16d, a grip portion 16a (16ya, 16ma, 16ca, 16ka), an elastic member 16g as an expansion and contraction member and a grip portion guiding portion 16e.

As shown in (a) and (b) of FIG. 19, 4 sets of developing cartridge guides 25R, 25L each extending in the horizontal direction are provided opposed to each other at inner surfaces of a right side frame 105R and a left side frame 105L of the apparatus main assembly 101. The developing cartridge guides 25R, 25L are constituted so that the photosensitive drum 1 is positioned in front of the developing cartridge guides 25R, 25L in a state in which the developing cartridges 16 are mounted into a developing cartridge mounting portion 102. Each of the developing cartridges 16 is detachably mountable to the mounting portion 102 by being guided at portions-to-be-guided 16Rb, 16Lb along guide rails 25R, 25L in a front-rear direction (arrow X1, X6 directions).

Incidentally, as shown in (a) and (b) of FIGS. 15A and 15B, the developing cartridges 16 are disposed so that casings 16h (16yh, 16mh, 16ch, 16kh) are in different positions with respect to the X1 direction relative to the apparatus main assembly 101. Correspondingly, as shown in FIG. 20, also abutting portions 25a (25ya, 25ma, 25ca, 25ka) of the developing cartridge guides 25 (25y, 25m, 25c, 25k) of the mounting portion 102 are similarly disposed at different positions with respect to the X1 direction.

Lengths of the casings 16h and the grip portions 16a with respect to the X1 direction are different from each other, and therefore in the case where the developing cartridges 16 are not mounted to proper locations, a door 10 is not completely closed, so that image formation cannot be effected.

When the developing cartridges 16 are exchanged, a demounting operation and a mounting operation of the developing cartridges 16 are performed. In the demounting operation, as shown in FIGS. 14 and 17, the door 10 is opened and then the user grips the grip portions 16Ra, 16La projecting through an opening 103 and moves the developing cartridges 16 from the mounting portion 102 in a demounting direction (X6 direction). Then, the portions-to-be-guided 16b (16yb, 16mb, 16cb, 16kb) are sufficiently spaced from the developing cartridge guiding portions 25R (25Ry, 25Rm, 25Rc, 25Rk) shown in FIG. 19, and then the developing cartridges 16 are taken out to the outside of the apparatus main assembly 101 and the door is closed.

The mounting operation is performed in reverse order. The user opens the door 10 and then gradually mounts the developing cartridges 16 into the mounting portion 102 in a mounting direction (X1 direction) in a state in which the user grips the grip portions 16Ra, 16La, and pushes the developing cartridges 16 to developing positions, and then closes the door 10. The user performs the mounting and demounting operations while gripping the grip portions 16Ra, 16La, so that there is no need to perform the operations by reaching into the apparatus main assembly 101 with hands, and therefore the user can easily perform the operations.

### (Structure of Grip Portion)

In FIG. 17, (a) is a left side view of the developing cartridge 16 in a state in which an external force exerted on the grip portion 16a does not generate with respect to the X1 direction, and (b) is a left side view of the developing cartridge in a state in which the external force exerted on the grip portion 16a generates with respect to the X1 direction. The grip portion 16a is connected with the casing 16h by the elastic member 16g, so that the grip portion 16a can be moved in parallel to the X direction or the X6 direction by a grip portion guiding portion 16e shown in (a) and (b) of FIG. 18.

In FIG. 18, (a) and (b) are sectional views, from a left side direction, each showing a portion connecting the grip portion 16a and the casing 16h, and (c) is a sectional view, from a front (surface) direction, showing the portion connecting the grip portion 16a and the casing 16h.

As shown in FIG. 18, the grip portion 16a is provided with a portion-to-be-guided 16f, and the casing 16h is provided with the grip portion guiding portion 16e capable of guiding the portion-to-be-guided 16f. For that reason, the grip portion 16a is movable between a most contracted position ((b) of FIG. 18) of the elastic member 16g and a most expanded position ((a) of FIG. 18) of the elastic member 16g.

Thus, as shown in FIGS. 15 and 18, in the case where the developing cartridge 16 is mounted in the apparatus main assembly 101, the grip portion 16a is in a first position (FIG. 15B, (b) of FIG. 18) when the door 10 is closed and is in a second position (FIG. 15A, (a) of FIG. 18) when the door 10 is open.

Here, as shown in (a) of FIG. 17, the elastic member 16g connecting the grip portion 16a and the casing 8h is an urging spring and always urges the grip portion 16a in the X6 direction relative to the casing 8h. For that reason, when the external force does not generate, the grip portion 16a is always in the second position, but when the external force exerted on the grip portion 16a with respect to the X1 direction generates, the grip portion 16a moves relative to the casing 8h. When the external force exerted on the grip portion 16a is not less than a certain level, the grip portion 16a moves to the first position shown in FIG. 13B. Then, from that state, when the external force is removed, by an urging force of the elastic member 16h, the grip portion 16a automatically moves to the second position.

Incidentally, as shown in (c) of FIG. 18, the lengths of the grip portions 16a are different from each other with respect to the X1 direction, and in a state in which the door 10 is open, the developing cartridges 16 are disposed at different positions relative to the apparatus main assembly 101 with respect to the X1 direction. However, the grip portions 16a are in a state in which right ends thereof are aligned with each other with respect to the X6 direction, so that the grip portions 16a can move to the outside of the apparatus main assembly 101 through the opening 103. For that reason, the user easily grips a desired developing cartridge 16 when the user grips the developing cartridge 16.

### (Structure of Door)

As shown in FIG. 13A, the door 10 is provided with a handle 10a. The user grips the handle 10a and then rotates the handle 10a from a closed state of the door 10 to an opened state of the door 10 as shown in FIG. 14. Further, as shown in FIG. 14 and FIG. 15A, the door 10 is provided with grip portion urging portions 10b at an inside surface of the apparatus main assembly 101 when the door 10 is closed. In FIG. 14, two grip portion urging portions 10b are disposed correspondingly to the left and right grip portions 16Ra, 16La, respectively, and are the same in shape, and are provided at positions where the grip portion urging portions 10b contact the associated grip portions 16a, respectively.

Incidentally, a material for the grip portion urging portions 10b is not particularly defined, but may only be required to be a material capable of absorbing an impact and a contact noise when the grip portion urging portions 10b contact the grip portions 16a, and for example, may also be an elastic member. In this embodiment, the two grip portion urging portions 10b are disposed at left and right positions, but may also be further divided or may also have different shapes as long as the resultant grip portion urging portion 10b have similar functions. Incidentally, when the inside surface of the door 10 is constituted by the material capable of absorbing the impact and the contact noise when the inside surface contacts the grip portions 9, the grip portion urging portions 10b may also be not provided, and the door 10 may also be directly contacted to the grip portions 16a.

(Interrelation Between Door and Grip Portion when Door is Opened)

In this embodiment, when the developing cartridges 16 are mounted in the apparatus main assembly 101, in interrelation with the opening and closing of the door 10, the grip portions 16a are moved between the first position and the second position and are disposed at the first position or the second position. In the following, motion of the grip portions 16a when the door 10 is opened will be described.

The developing cartridges 16 are, as shown in FIG. 15B, in a state in which the grip portions 16a are disposed at the first position when the developing cartridges 16 are mounted in the mounting portion 102 and the door 10 is closed. In this state, the door 10 urges the grip portions 16a in the X1 direction through the grip portion urging portions 10b. At this time, as shown in (b) of FIG. 18, the portions-to-be-guided 16f are in positions closest to downstream ends of the grip portion guiding portions 16e with respect to the X1 direction, and urge the casing 16h in the X1 direction.

In this state, the portions-to-be-guided 16f (16yf, 16mf, 16cf, 16kf) shown in FIG. 18 are guided by the developing cartridge guides 25 (25y, 25m, 25c, 25k) shown in FIG. 19. In addition, the portions-to-be-guided 16f contact the abutting portions 25a (25ya, 25ma, 25ca, 25ka) shown in FIG. 20. For that reason, the abutting portions 25a are in a state in which the abutting portions 25a receive the external force from the door 10 through the portions-to-be-guided 16f and the casings 16h. Incidentally, a state in which the abutting portions 25a and the portions-to-be-guided 16f are in contact with each other is such a state that the developing cartridges 16 are sufficiently mounted into the mounting portion 102.

Here, each of the developing cartridge guides 25 has a snap-fit mechanism which narrows in width at a periphery of the abutting portion 25a guides 25 contacts the abutting portion 25a, the developing cartridge 16 does not move in the X1 direction with no external force with respect to the X1 direction.

In order to place the door 10 from the closed state to the opened state as described above, the door 10 is rotated. FIG. 15C is a sectional view, from the left side direction, of the developing cartridge mounting portion 102 in a state in which the door 10 is opened in a certain degree (amount). The door 10 is opened, whereby the displace urging portions 10b urge the grip portions 16a and thus a displaced amount decreases. The grip portions 16a are urged from the casing 16h in the X6 direction through the elastic members 16g (16yg, 16mg, 16cg, 16kg), and therefore by rotation of the door 10, the grip portions 16a move in the X6 direction in a contact state with the grip portion urging portions 10b.

Incidentally, a part of the portions-to-be-guided 16f is mounted to a part of the developing cartridge guiding portions 25 by snap fitting, and therefore the developing cartridge 16 is disposed at the same position as the position thereof before the door 10 is opened.

Then, the door 10 is further opened and is placed in a sufficiently opened state. FIG. 15A is a sectional view, from the left side direction, of the mounting portion 102 in a state in which the door 10 is rotated and sufficiently opened. When the door 10 is sufficiently opened, urging and displacement which are given from the grip portion urging portions 10b to the grip portions 16a with respect to the X1 direction are eliminated.

As a result, the grip portions 16a are in a state in which only the external force for urging the grip portions 16a from the casing 16h in the X6 direction generates, so that the grip portions 16a are disposed at the second position where the grip portions 16a move in the X6 direction to the maximum. As shown in (a) of FIG. 18, the grip portions 16a are in a state in which the grip portions 16a move to downstream ends of the grip portion guiding portions 16e with respect to the X6 direction. Incidentally, also in this state, the developing cartridge 16 is not moved based on the snap-fit mechanism, and therefore the developing cartridge 16 is disposed at the same position as the position before the door 10 is opened.

Thus, the developing cartridge 16 in this embodiment can be demounted from the mounting portion 102. A perspective view of an outer appearance of the image forming apparatus after the developing cartridge 16y is removed from the image forming apparatus is shown in FIG. 16.

(Interrelation Between Door and Grip Portion when Door is Closed)

Next, motion of the grip portions 16a when the door 10 is closed in a state in which the developing cartridge 16 is sufficiently or insufficiently mounted in the apparatus main assembly 101 will be described. Incidentally, an insufficiently mounted state in such a state that the developing cartridge 16 is mounted in the mounting portion 102, but a part of the portions-to-be-guided 16b (16yb, 16mb, 16cb, 16kb) does not contact the abutting portion 25a of the developing cartridge guiding portion 25.

In the following, first, behavior in a state in which the developing cartridges 16 are sufficiently mounted in the apparatus main assembly 101 will be described. When the developing cartridges 16 are sufficiently mounted in the mounting portion 102 and the door 10 is opened, the developing cartridges 16 are in a state shown in FIG. 15A. In this state, there is no contact of the grip portions 16a with the grip portion urging portions 10b on the door 10.

For that reason, the grip portions 16a are in a state in which only the external force for urging the grip portions 16a from the casing 16h in the X6 direction through the elastic member 16g generates, so that the grip portions 16a are disposed at the second position where the grip portions 16a move in the X6 direction to the maximum. Thus, as shown in (a) of FIG. 18, the portions-to-be-guided 16f are in a state in which the portions-to-be-guided 16f move to downstream ends of the grip portion guiding portions 16e with respect to the X6 direction.

From that state, the door 10 is gradually rotated in a closing direction. When the door 10 is opened to a certain extent or more, the grip portion urging portions 10b contact end portions of the grip portions 16a. When the developing cartridges 16 are sufficiently mounted in the mounting portion 102, the developing cartridges 16 cannot be further moved in the X1 direction. For that reason, when the grip portions 16a are further urged from that state in the X1 direction with the grip portion urging portions 10b by rotation of the door 10, the elastic member 16g contracts in the X1 direction, and therefore as shown in FIG. 15C, the grip portions 16a start to move in the X1 direction.

As shown in FIG. 15B, the grip portions 16a are disposed at the first position when the door 10 is sufficiently closed. In this state, the door 10 urges the grip portions 16a in the X1 direction through the grip portion urging portions 10b. At this time, as shown in (b) of FIG. 18, the portions-to-be-guided 16f are in positions closest to downstream ends of the grip portion guiding portions 16e with respect to the X1 direction, and are in a state in which the portions 16f urge the casing 16h in the X1 direction.

Next, behavior in a state in which the developing cartridges 16 are not sufficient mounted in the mounting portion 102 will be described. In the case where the developing cartridges 16 are not sufficiently mounted in the mounting portion 102 and the door 10 is opened, different from the case where the developing cartridges 16 are sufficiently mounted in the mounting portion 102, the grip portions 16a are in a state in which the grip portions 16a are not aligned with each other with respect to the X6 direction.

From that state, when the door 10 is gradually rotated in the closing direction, similarly as in the case where the developing cartridges 16 are sufficiently mounted in the mounting portion 102, when the door 10 is rotated to a certain degree (amount) or more, the grip portion urging portions 10b and end portions of the grip portions 16a are in contact with each other. However, when the developing cartridges 16 are insufficiently mounted in the mounting portion 102, even after the contact between the grip portion urging portions 10b and the end portions of the grip portions 16a, by rotating the door 10 in the closing direction, the developing cartridges 16 can be further moved in the X1 direction.

After the contact between the grip portion urging portions 10b and the end portions of the grip portions 16a, when the door 10 is gradually closed, the developing cartridges 16 are gradually moved in the X1 direction in a state in which the elastic member 16g is contracted in a certain amount in the X1 direction by a certain distance. Then, the door 10 is further closed and when the developing cartridges 16 are pushed into the mounting portion 102 in the X1 direction in a certain amount or more, a part of the portions-to-be-guided 16b gradually approaches the abutting portions 25a (FIG. 20) of the developing cartridge guiding portions 25.

Here, in the neighborhood of the abutting portion 25a, the snap-fit mechanism includes the developing cartridge guiding portion 25 where the guiding width narrows. For that reason, a frictional force received by the portions-to-be-guided 16b from the developing cartridge guiding portion 25 in the X6 direction increases. Further, a largest frictional force generating when the developing cartridges 16 are mounted is larger than a resisting force generating when all of the grip portions 16a are urged from the second position to the first position.

Accordingly, in FIG. 18, as a part of the portions-to-be-guided 16b approaches the abutting portions 25a (FIG. 20), the elastic member 16g contracts in the X1 direction, so that the portions-to-be-guided 16f move to positions closest to a downstream end of the grip portion guiding portion 16g with respect to the X1 direction. In that state, displacement of the grip portions 16e relative to the casing 16h is eliminated, and therefore the grip portions 16a and the casing 16h move together in the X1 direction.

Then, from the door 10, when an external force larger than the frictional force received by the portions-to-be-guided 16b from the developing cartridge guiding portion 25 in the X6 direction is applied through the grip portions 16a and the casing 16h, a part of the portions-to-be-guided 16b contacts the abutting portion 25a. In this state, as shown in FIG. 15B, the developing cartridges 16 are in a state in which the developing cartridges 16 are sufficiently mounted in the mounting portion 102, and also the door 10 is in a state in which the door 10 is sufficiently closed.

### Modified Embodiments

In the above-described embodiments, preferred embodiments of the present invention were described, but the present invention is not limited thereto and various modifications can be made within the scope of the present invention. Further, technical matters described in the embodiments mentioned above can also be employed in other embodiments.

According to the present invention, during exchange of the cartridge, the user is capable of exchanging (replacing) the cartridge without reaching into the image forming apparatus main assembly with hand(s), so that the exchanging (replacing) operation can be performed easily.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-103558 filed on May 21, 2015, which is hereby incorporated by reference herein in its entirety.

What is claimed is:

1. An image forming apparatus comprising:
a main assembly; and
a cartridge capable of supplying developer and detachably mountable to said main assembly,
wherein said main assembly includes a mounting portion for mounting said cartridge and a door for causing said mounting portion to be in an open state and a closed state,
wherein said main assembly or said cartridge includes an expansion and contraction member for displacing at least a part of said cartridge,
wherein opening and closing of said door is interrelated with expansion and contraction of said expansion and contraction member,
wherein in the closed state, said cartridge mounted in said mounting portion is in a first position, inside said main assembly, where an image is formable, and
wherein in the open state, said cartridge mounted in said mounting portion is in a second position where at least a part thereof projects to an outside of said main assembly.

2. An image forming apparatus according to claim 1, wherein said expansion and contraction member displaces said cartridge mounted in said mounting portion integrally with said mounting portion, and
wherein at the second position, said cartridge and said mounting portion are projected to the outside of said main assembly.

3. An image forming apparatus according to claim 2, further comprising a moving member, provided in said main assembly, for moving the developer from said cartridge to said main assembly,
wherein said moving member has a bellow shape and is expanded and contracted by said expansion and contraction member.

4. An image forming apparatus according to claim 1, wherein said cartridge includes a grip portion for being gripped when said cartridge is mounted into and demounted from said main assembly,
wherein said expansion and contraction member displaces said grip portion in a state in which said mounting portion is not displaced, and
wherein said grip portion is accommodated inside said main assembly at the first position and is projected to the outside of said main assembly at the second position.

5. An image forming apparatus according to claim 1, wherein said door includes, at an inner surface facing the inside of said main assembly in the closed state, an urging portion for relaxing an impact when said urging portion contacts at least a part of said cartridge projecting to the outside of said main assembly.

6. An image forming apparatus according to claim 1, wherein a direction of at least a part of said cartridge projecting to the outside of said main assembly is a same direction as a demounting direction of said cartridge.

7. An image forming apparatus according to claim 6, wherein the same direction is a vertical direction.

8. An image forming apparatus according to claim 1, wherein a direction of at least a part of said cartridge projecting to the outside of said main assembly is a horizontal direction.

9. An image forming apparatus according to claim 1, wherein said cartridge includes a plurality of cartridges provided correspondingly to different colors.

10. An image forming apparatus according to claim 9, wherein mounting positions of the plurality of cartridges are different from each other with respect to a common mounting direction of the plurality of cartridges.

11. An image forming apparatus according to claim 9, further comprising grip portions for being gripped when the plurality of cartridges are mounted into associated mounting portions,
wherein a difference in projected position between the grip portions is smaller than a difference in position between the mounting portions with respect to a mounting direction.

12. An image forming apparatus according to claim 11, wherein end portion positions of the grip portions are aligned with a predetermined surface so as to eliminate the difference in projected position between the grip portions.

13. An cartridge capable of supplying developer and detachably mountable to a main assembly of an image forming apparatus including a mounting portion and a door for causing the mounting portion to be in an open state and a closed state, said cartridge comprising:
a grip portion; and
an expansion and contraction member for displacing said grip portion while maintaining said cartridge at a position where said cartridge is mounted in the mounting portion,
wherein said grip portion is in a first position where an image is formable inside the main assembly in the closed state and is in a second position where said grip portion projects to an outside of the main assembly in the open state.

14. A cartridge according to claim 13, which is a toner cartridge.

15. A cartridge according to claim 13, which is a developing cartridge including a developing roller.
